(19) United States
(12) Patent Application Publication
(10) Pub. No.: US 2023/0315789 A1
(43) Pub. Date: Oct. 5, 2023

(54) CONFIGURATION-DRIVEN QUERY COMPOSITION FOR GRAPH DATA STRUCTURES FOR AN EXTENSIBILITY PLATFORM

(71) Applicant: Cisco Technology, Inc., San Jose, CA (US)

(72) Inventors: Horst Werner, Concord, CA (US); Geoffrey R. HENDREY, San Anselmo, CA (US); Nachiket P. MISTRY, Bothell, WA (US)

(21) Appl. No.: 18/128,504

(22) Filed: Mar. 30, 2023

Related U.S. Application Data
(60) Provisional application No. 63/326,179, filed on Mar. 31, 2022.

(51) Int. Cl. G06F 16/9038; G06F 16/901; G06F 16/903; G06F 9/451

(52) U.S. Cl. CPC G06F 16/9038; G06F 16/9024; G06F 16/9027; G06F 16/90335; G06F 9/451

(57) ABSTRACT

In one embodiment, an example method herein may comprise: determining, for a particular customized user interface instance, specific configurations of specific building blocks of a plurality of configurable atomic building blocks provided by a user interface platform, the specific configurations defining hierarchies between child component data and parent component data that result in a component tree; determining information requirements of the specific building blocks corresponding to components of the component tree; consolidating the information requirements into a single query request according to query language of a backend system, the single query request consisting of a single continuous subgraph; submitting the single query request to the backend system to obtain a query result; and rendering the particular customized user interface instance based on translating the query result into a data tree that recursively passes the query result from parent components to child components within the component tree.

### RELATED APPLICATION

This application claims priority to U.S. Prov. Appl. No. 63/326,179, filed Mar. 31, 2022, entitled CONFIGURATION-DRIVEN QUERY COMPOSITION FOR GRAPH DATA STRUCTURES FOR AN EXTENSIBILITY PLATFORM, by Werner, et al., the contents of which are incorporated herein by reference.

### TECHNICAL FIELD

The present disclosure relates generally to computer systems, and, more particularly, to a configuration-driven query composition for graph data structures for an extensibility platform.

### BACKGROUND

The Internet and the World Wide Web have enabled the proliferation of web services available for virtually all types of businesses and many online applications now rely on a distributed set of web services to function. These web services introduce complex data dependencies, complex data handling configurations, and various other operational nuances, which make monitoring them particularly challenging. Indeed, the monitoring and logging of data across web services is currently handled today in a discrete and/or non-centralized fashion with respect to each web service. Doing so in this manner also makes it difficult to associate the logged data across the different web services. In addition, monitoring the web services in a discrete manner also runs the risk of breaking the software application already running in the cloud, such as when monitoring code is added for one web service without accounting for where that web service fits within the overall execution of the application and with respect to its dependencies, data handling, etc. This discrete treatment of monitoring web services has led to isolation of data collected from these web services and prevented users from querying the collected data. Even if a centralized monitoring platform utilizable across the various web services existed, it would remain challenging to present query results on the monitored data to a user in a manner that remains interpretable.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of layers of full-stack observability;

FIG. 5 illustrates an example platform data flow;

FIG. 6 illustrates an example of a Flexible Meta Model (FMM);

FIGS. 7A-7B illustrate a high-level example of a container orchestration domain model;

FIG. 8 illustrates an example of a sophisticated subscription and layering mechanism;

FIG. 9 illustrates an example interplay of tenant-specific solution subscription with cell management;

FIG. 10 illustrates an example of exposure of different configuration stores as a single API;

FIGS. 11A-11E illustrate an example of a common ingestion pipeline, in particular where each of FIGS. 11A-11E illustrate respective portions of the pipeline;

FIG. 12 illustrates an example of resource mapping configurations;

FIG. 13 illustrates an example of a design of a Unified Query Engine (UQE);

FIG. 14 illustrates an example of a deployment structure of an observability intelligence platform in accordance with the extensibility platform herein, and the associated cell-based architecture;

FIGS. 15A-15D illustrate an example of a system for utilizing a configuration-driven data processing pipeline for an extensibility platform, in particular where each of FIGS. 15A-15D illustrate respective quadrants of the system;

FIG. 16 illustrates an example diagram depicting the configuration-driven query composition for graph data structures herein;

FIG. 17 illustrates an example of building an instantiated UI element from a template and data;

FIG. 18 illustrates an example data flow and rendering of an example herein;

FIG. 19 illustrates an example composition hierarchy of the page and a simplified version of the corresponding tree of data request nodes;

FIGS. 20A-20C illustrate example screenshots of a resultant dashboard according to the techniques herein; and

FIG. 21 illustrates an example simplified procedure for a configuration-driven query composition for graph data structures for an extensibility platform, in accordance with one or more embodiments described herein.

### DESCRIPTION OF EXAMPLE EMBODIMENTS

### Overview

According to one or more embodiments of the disclosure, a configuration-driven query composition for graph data structures for an extensibility platform is described herein. In particular, all data structures can be seen as graphs of entities, where each entity has properties and relationships to other entities. An activity-specific User Interface (UI) typically displays one subgraph centered around a currently selected set of entities (the scope). Also, the composition tree of the components is typically reflected by one or multiple tree structures embedded in said subgraph. Because that data path is relative, and doesn't require knowledge of the absolute definition of information represented by the parent component, it is possible to dynamically configure hierarchies of components and then derive the full structure of the subgraph required to render these components from the data paths. Combined with the knowledge of the set of entities bound to the root component (the scope), this structure can then be translated into an optimized query with no redundant requests, which provides the data required to render the UI. In combination with a backend providing some form of query language that supports dynamically querying graph structures, new activity specific UIs can be developed by mere configuration without making any changes to frontend or backend code.

Specifically, according to one or more embodiments of the disclosure, an illustrative method herein may comprise determining, for a particular customized user interface instance, specific configurations of one or more specific building blocks of a plurality of configurable atomic building blocks provided by a user interface platform, the specific configurations defining hierarchies between child component data and parent component data that result in a component tree; determining one or more information requirements of the one or more specific building blocks corresponding to components of the component tree; consolidating the one or more information requirements into a single query request according to query language of a backend system, the single query request consisting of a single continuous subgraph; submitting the single query request to the backend system to obtain a query result; and rendering the particular customized user interface instance based on translating the query result into a data tree that recursively passes the query result from parent components to child components within the component tree.

Other embodiments are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

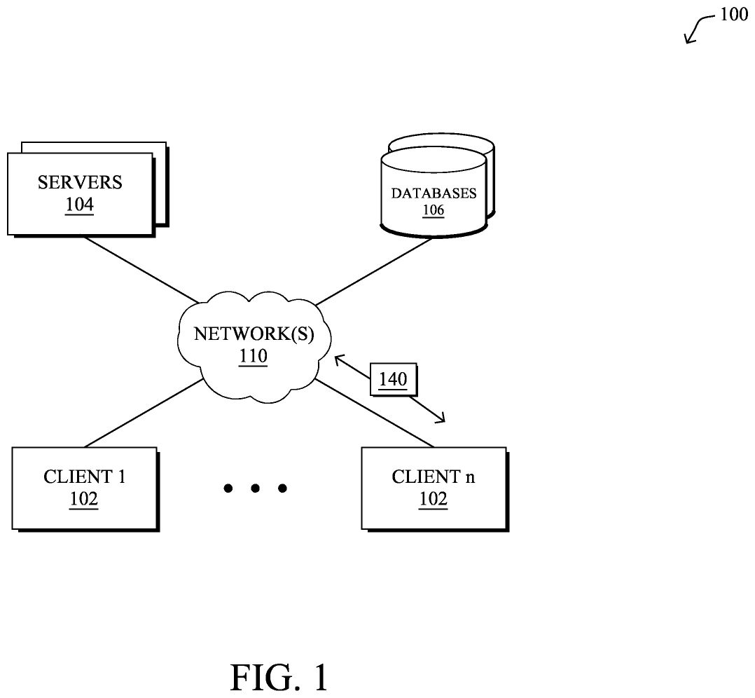

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

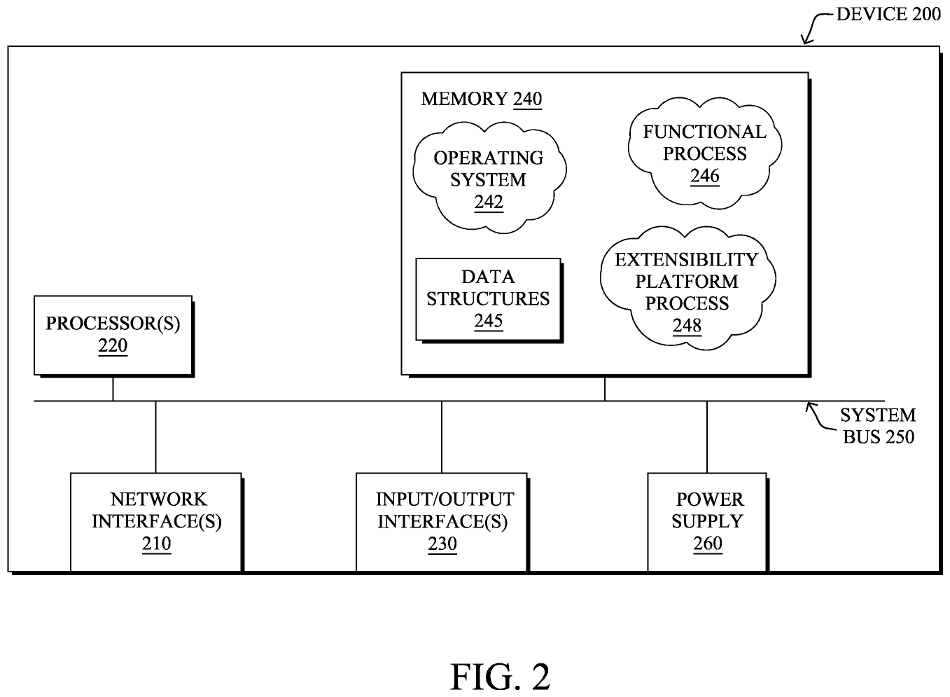

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “extensibility platform” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

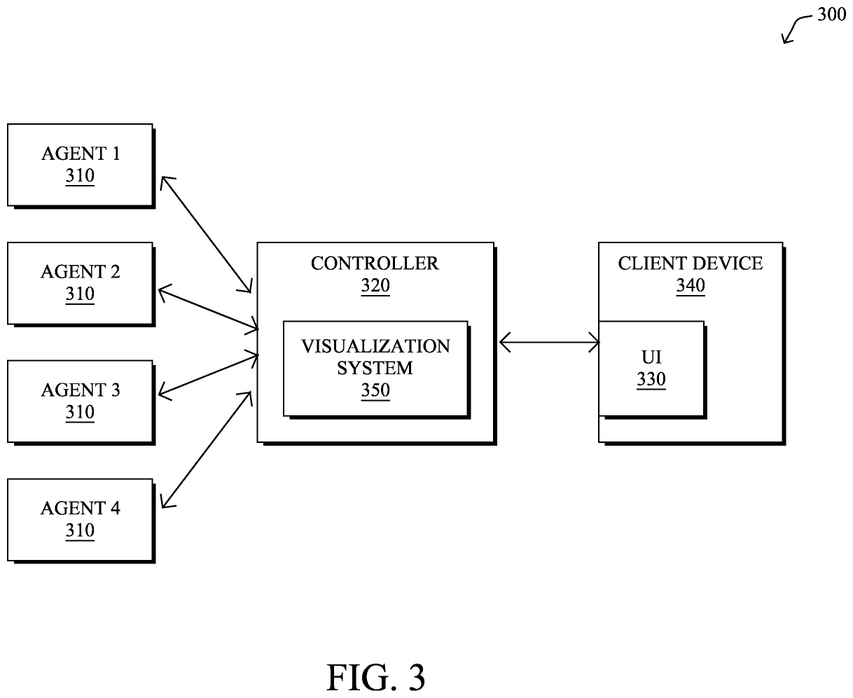

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, an instance of controller 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### An Extensibility Platform

One specific example of an observability intelligence platform above is the AppDynamics Observability Cloud (OC), available from Cisco Systems, Inc. of San Jose, California. The AppDynamics OC is a cloud-native platform for collecting, ingesting, processing and analyzing large-scale data from instrumented complex systems, such as Cloud system landscapes. The purpose of the platform is to host solutions that help customers to keep track of the operational health and performance of the systems they observe and perform detailed analyses of problems or performance issues.

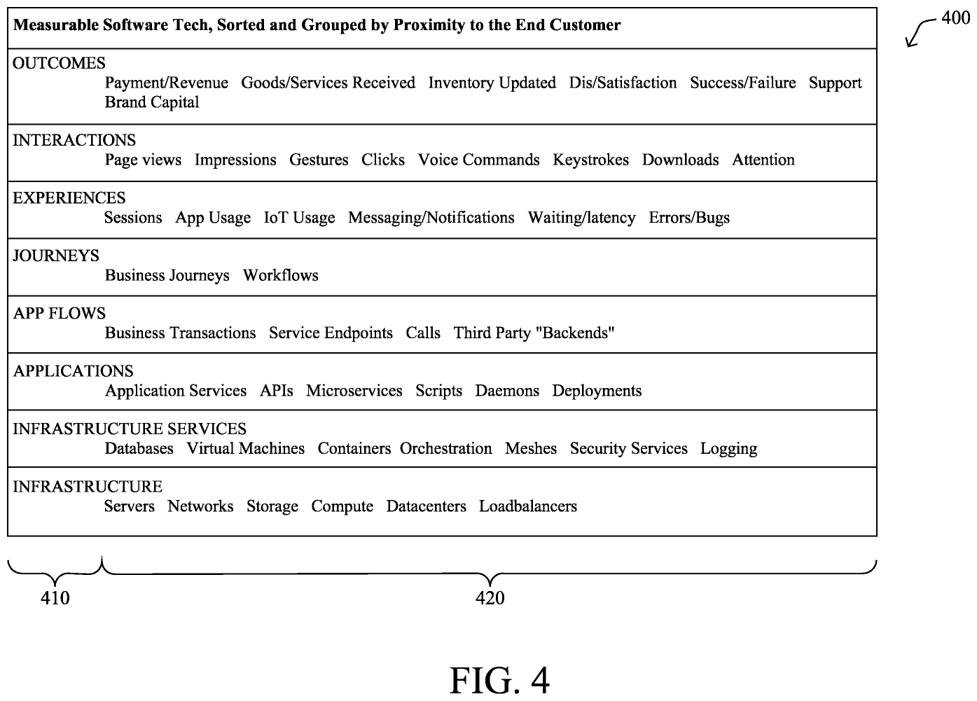

AppDynamics OC is designed to offer full-stack Observability, that is, to cover multiple layers of processes ranging from low-level technical processes such as networking and computing infrastructure over inter-service communication up to interactions of users with the system and business processes, and most importantly, the interdependencies between them. FIG. 4, for example, illustrates an example 400 of layers of full-stack observability, demonstrating measurable software technologies, sorted and grouped by proximity to the end customer. For instance, the layers 410 and associated technologies 420 may be such things as:
Outcomes:
   payment/revenue; goods/services received; inventory updated; dissatisfaction/satisfaction; success/failure; support; brand capital; etc.
Interactions:
   page views; impressions; gestures; clicks; voice commands; keystrokes; downloads; attention; etc.
Experiences:
   sessions; app usage; IoT usage; messaging/notifications; waiting/latency; errors/bugs etc.
Journeys:
   business journeys; workflows; etc.
App Flows:
   business transactions; service endpoints; calls; third party “backends”; etc.
Applications:
   application services; APIs; microservices; scripts; daemons; deployments; etc.
Infrastructure Services:
   databases; virtual machines; containers; orchestration; meshes; security services; logging; etc.
Infrastructure:
   servers; networks; storage; compute; datacenters; load balancers; etc.

Each of these layers has different types of entities and metrics that need to be tracked. Additionally, different industries or customers may have different flavors of each layer or different layers altogether. The entirety of artifacts represented in each layer and their relationships can be described—independent of any digital representation—in a domain model.

In the development of a conventional application, the domain model is encoded in a data model which is pervasively reflected in the coding of all parts of a solution and thus predetermines all its capabilities. Any substantial extension of these capabilities requiring changes in the data model results in a full iteration of the software lifecycle, usually involving: Updating database schemas, data access objects, in-memory representation of data, data-processing algorithms, application interface (API), and user interface. The coordination of all these changes to ensure the integrity of the solution(s) is particularly difficult in cloud-native systems due to their distributed nature, and substantial teams in every software company are dedicated to this task.

The task becomes harder the more moving parts and the more actors are involved. But the sheer bandwidth of domain models and functionality hinted at in FIG. 4 above makes it all but impossible for a single company to deliver all the required solutions in a centralized development process. A platform thus should allow customers and partners to adapt and extend the solutions, or even provide entirely new solutions, with minimal risk of breaking or compromising the production system running in the cloud. The biggest challenge lies in the fact that all these solutions are not isolated from each other but must run for each tenant as an individually composed, integrated application sharing most of the data and infrastructure.

In order to make this possible, the techniques herein are directed at taking a novel approach to solution composition, informed by elements of model-driven architecture, graph data models, and modern pull-based software lifecycle management. That is, the techniques herein, therefore, are directed toward an extensibility platform that provides a solution packaging system that allows for data-type dependencies.

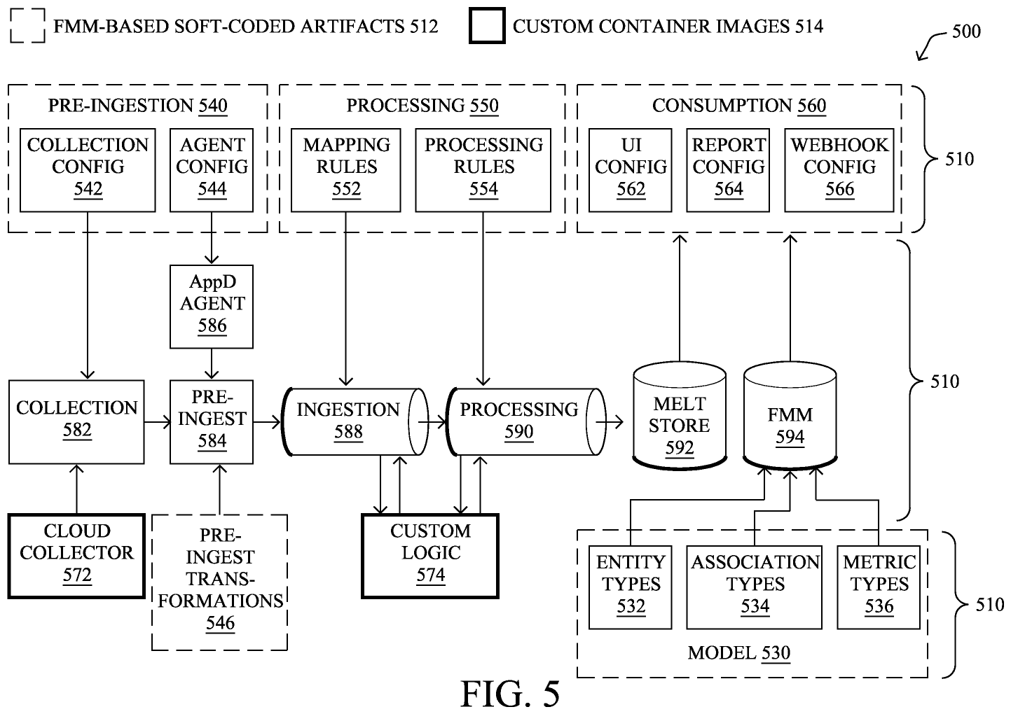

Operationally, the extensibility platform is built on the principle of strictly separating the solutions from the executing platform's technology stack in order to decouple their respective life cycles. The solutions are very much (e.g., almost entirely) model-driven, so that the platform can evolve and undergo optimizations and technological evolution without affecting the existing solutions. In the rare cases in which the models are not powerful enough, custom logic can be provided as a Function as a Service (FaaS) or container image exposing a well-defined service interface and running in a strictly controlled sandbox. FIG. 5, for instance, showing a platform data flow 500 (described further below), illustrates how different solution-specific artifacts 510 interact with the platform's core functionality 520 (e.g., the data flow in the middle).

Solutions herein thus provide artifacts that enrich, customize, or alter the behavior data ingestions, processing, and visualizations. This allows a company and/or application such as IT management companies/apps to provide a customized monitoring solution for data management platforms (e.g., NoSQL databases), for example, on the observability intelligence platform above. Such a custom solution may therefore include the definition of data management platform entities that are monitored, and the relationship between those entities, and their metrics. The example IT management app for data management platforms can also provide enrichments to the user interface, such as providing distinct iconography for their entities, and bundling dashboards and alerts that take particular advantage of data management platform-specific metrics, such as a data management platform heartbeat metric. This same system of packaging may be used to provision the system with having “core” domains specific to the illustrative observability intelligence platform, the only difference being that subscription to system apps is automatic. In addition, first party apps like EUM may also leverage the same system.

In particular, the extensibility platform techniques herein are directed to a solution packaging system that allows for data-type dependencies. It is essentially the JSON store and solution packaging that are collectively referred to herein as “Orion”. The system is designed to allow modules to have dependencies like a traditional code/packaging system like java+maven, while simultaneously allowing these models to define their data model, access to that data model, packaging of objects conforming to other data solution data models, etc. This relies heavily on the concept of “layering”. While other systems may allow layering of local files, the ability to have layers that include global dynamic layers, as well as static global layers provided as part of a solution is never before seen, and solves a big problem.

As described herein, the techniques herein provide a system designed to provide “full stack observability” for distributed computer systems. That is, the system provides the ability to receive Metrics, Events, Logs, and Traces (MELT) data/signals in accordance with Open Telemetry standards. It also provides the ability to maintain an internal model of the actual entities being observed, as well as an ability to map incoming data/signals to entities under observation. Further, the extensibility platform herein provides the ability to query the entities of the system with regard to their associated MELT data/signals, and to infer health and other computed signals about entities. Entities may also be grouped together into composite entities to thus receive, generate, and maintain data/signals about composite entities, accordingly. Moreover, as detailed herein, the platform also has an openness to first, second, and third parties to “extend” all of the above so that the platform can continuously incorporate new use cases without each use case having to be “hand written” by the core engineering team.

The techniques herein also provide extensibility in a multi-tenant, app-aware, platform for MELT data processing, allowing for third parties to create solutions to which tenants can subscribe, and allowing for system capabilities to be defined and packaged in a way that is functionally identical to third party solutions. In addition, this allows third parties to extend the platform with capabilities not previously envisioned, such as, e.g., to augment the platform with new data types and storage for instances of those types, to augment the platform with new functions (lambda style), to augment the platform interfaces (REST, gRPC) with new APIs whose implementation is backed by lambda style functions and data storage, to augment the platform's built-in data processing in ways that benefit the solution without impacting tenants who have not subscribed to the solution, and so on.

Through providing extensibility in a multi-tenant, app-aware, platform for MELT data processing, the techniques herein also provide an extensible object modeling system for a multi-tenant microservices architecture. This allows dynamic composition of objects from mutable layers, which allows for applications/solutions to define object types, and for applications/solutions to bundle object instances (instances may be of a type defined by another solution that is a dependency or defined locally in the same solution). It also allows for tenants to override application/solution values, which enables tenants to customize the behavior of a solution.

The dynamic composition of objects from mutable layers also allows an implementation comprised of a tree-shaped object layering system with layers/awareness for, illustratively:
depth 0 (tree root): global system settings/fields;
depth 1: global application/solution constructs;
depth 2: account (a collection of tenants spanning multiple cells);
depth 3: tenant; and
depth 4: user.
   Moreover, the dynamic composition of objects from mutable layers further allows a communication system between globally distributed cells to enable each cell to have a synchronized local copy of the global layers, as well as a read-time composition system to compose object from layers.

The extensible object modeling system for a multi-tenant microservices architecture further provides a system for global solution management, which comprises a method of packaging apps/solutions, a method of declaring dependencies between solutions, a customer facing solution registry allowing developers to list their solutions, and so on.

The multi-tenant microservices architecture further provides a type system of meta-data for defining objects and their layers. That is, the techniques herein allow for specifying the shape of objects, declaring global/solution level object instances inside of solution packages, specifying which fields of the object support layering, specifying which fields are secrets, allowing inter-object references (e.g., allowing runtime spreading of fields to support inheritance and other use cases, allowing recursive prefetching of fields, allowing references to global object-layer-resident instances, etc.), and so on.

Additionally, the multi-tenant microservices architecture herein provides a system for managing object storage and retrieval by type. For instance, such a system may define a method of routing traffic to object stores based on the object type (e.g., a federation of object stores providing a single API/facade to access all types), as well as allowing atomic, eventually consistent maintenance of references between objects.

The extensible object modeling system for a multi-tenant microservices architecture additionally provides a system for ensuring atomicity of installation and updates to multi-object application/solutions across microservices in a cell. It also provides a library/client that allows pieces of our internal system to query and observe objects for changes (e.g., allowing MELT data ingestion pipeline to store configuration objects in memory, and avoiding having to query for “freshness” each time the object is needed).

As detailed herein, there are numerous concepts generally addressed by the extensibility platform of the present disclosure. Such concepts may comprise such things as:
a programmable data ingestion framework;
atomic maintenance of references between objects in a distributed type system;
atomicity of keys in document shredding for domain events;
automation of sagas in a distributed object store;
type systems in functions as a service (FaaS);
large scale data collection programmable by an end user;
managing multi-tenancy in data ingestion pipeline;
federation of a distributed object store;
improvements to operations in a distributed object store;
expression of user interface customization in terms of flexibly defined entity models;
a system of type layering in a multitenant, global distributed system;
customizing the inputs of a multi-tenant distributed system;
management of secure keys in a distributed multi-tenant system;
managing secure connections to external systems in a “bring your infrastructure” scenario;
automating workflows for the collection of secrets in a layered configuration system;
protecting developer secrets in FaaS environment;
Optimization of FaaS using intelligent caching in a programmable distributed data environment;
automating failover and restoration in a cell based architecture;
a modular entity modeling system;
a potential replacement for traditional telemetry for dashboards;
eventually consistent deployment of artifacts in distributed data processing pipeline;
Configuration-driven extensible MELT data processing pipeline;
Extracting additional value from the MELT data via customizable workflows;
Creating a graph-centric model from MELT data for observability;
Tag-aware attribute based access control for distributed systems;
Metadata-based graph schema definition;
Ensuring fairness in a multi-tenant system via rate limiting;
Configuration-driven Query Composition for Graph Data Structures;
And so on.

Notably, and to aide in the discussion below, the smallest deployable unit of extension is a “solution”, which is a package of models, configurations, and potentially container images for customizing extension points. Solutions can depend on other solutions. For example, a system health solution depends on a “Flexible Meta Model” (FMM) solution (described below), since health apps provide entities and metrics that depend on an FMM-type system. Core solutions may be automatically installed in each cell (e.g., similar to how certain platforms come with certain libs pre-installed with the system). Note further that a “solution artifact” is a JSON configuration file that a solution uses to configure an extension point.

An extension point, that is, is a part of the extensibility platform that is prepared to accept a configuration or other artifact to steer its behavior. Since the architecture of the extensibility platform herein is largely model-driven, most of the extensions can be realized by means of soft-coded artifacts: Model extensions and configurations expressed as JSON or other declarative formats. For instance, as shown in the extensibility platform data flow 500 in FIG. 5, soft-coded extension artifacts 512 are shown, while for more complex—or stateful—logic, services can be plugged in, i.e., custom container images 514. The extension points can be divided into four groups, Model, Pre-Ingestion, Processing, and Consumption, as shown:
Model 530 (e.g., entity types 532, association types 534, and metric types 536);
Pre-Ingestion 540 (e.g., collection configuration 542, agent configuration 544, and pre-ingestion transformations 546);
Processing 550 (e.g., mapping rules 552, and processing rules 554); and
Consumption. 560 (e.g., UI configuration 562, report configuration 564, and webhook configuration 566)
   Moreover, custom container images 514 may comprise such things as a Cloud Collector 572 and Custom Logic 574.

As also shown in FIG. 5, the platform's core functionality 520 may comprise collection 582, pre-ingestion 584 (e.g., with agent configuration 544 coming via an observability or “AppD” agent 586), ingestion 588, processing 590, MELT store 592, and an FMM 594, with the functionalities being interconnected to each other and/or to the different solution-specific artifacts 510 as shown, and as generally described in detail herein.

Regarding details of the extensibility platform of the present disclosure, at the core of the extensibility platform herein is the Flexible Meta Model (FMM), which allows creation of models of each solution's specific artifacts, that is, entities (such as services or user journeys) and their associated observed data: Metrics, Events, Logs and Traces (together abbreviated as MELT).

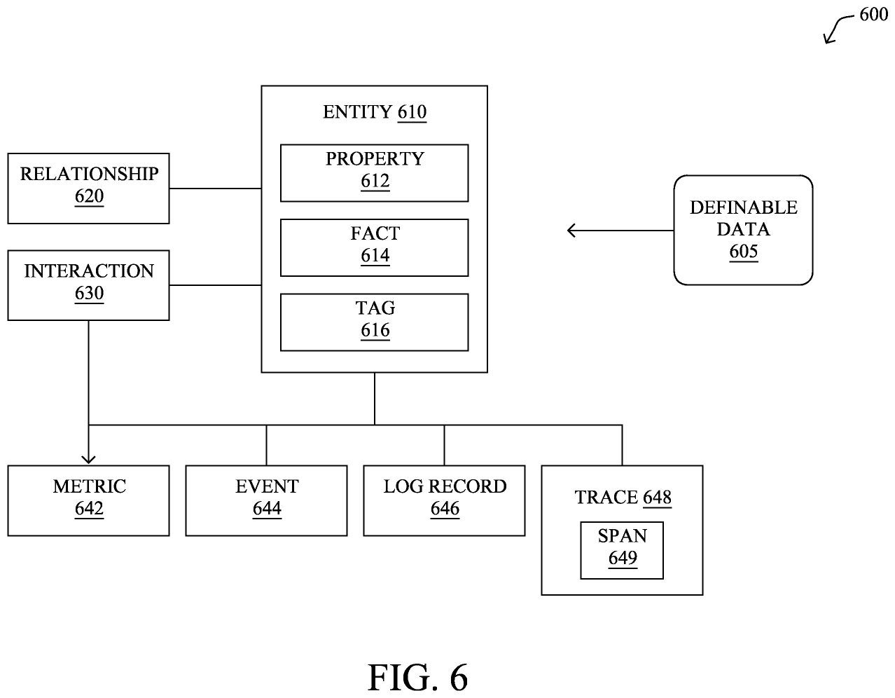

FIG. 6 shows a simplified schematic of the FMM 600. Each of the shaded boxes represents a “kind” of data 605 for which specific types (and instances) can be defined. Entity types 610 may have a property 612, fact 614, and tag 616. Examples for entity types 610 are: Service, Service Instance, Business Transaction, Host, etc.

Relationship types 620 define how entities are associated to each other (for example “contains” or “is part of”). Interaction types 630 describe how entities interact with each other. They combine the semantics of association types (e.g., a service “calls” a backend) with the capability of entity types to declare MELT data (Metric 642, Event 644, Log Record 646, and Trace 648 (with Span 649). In one embodiment, interaction types are treated just like entity types, though not so in other embodiments.

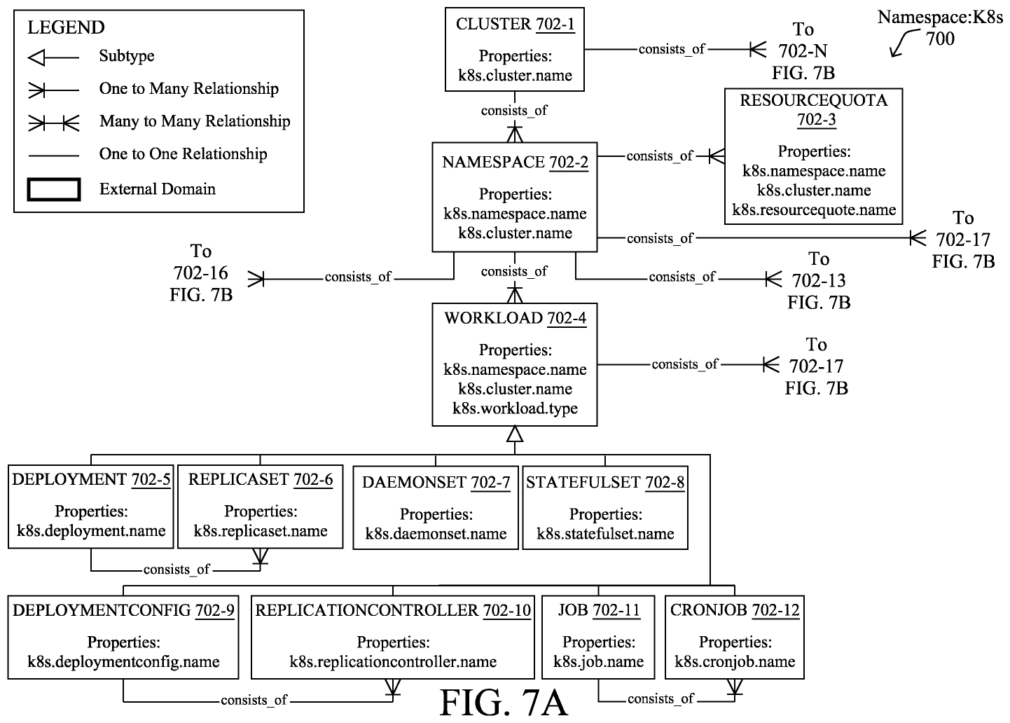

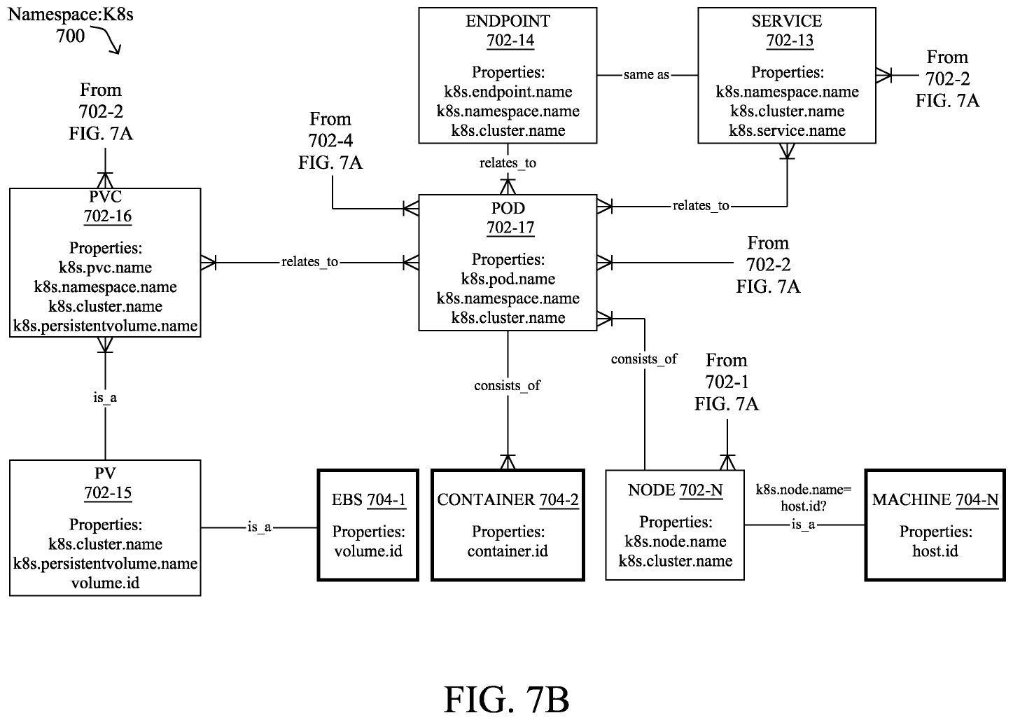

Based on this meta model, models of specific domains (such as a container orchestration) can be created. For instance, FIGS. 7A-7B illustrate a high-level example of a container orchestration domain model 700 (e.g., a Kubernetes or “K8s” domain model). The container orchestration domain model 700 may be made up of model components 702 (e.g., 702-1 . . . 702-N) organized with the illustrated relationships (e.g., subtype, one-to-many relationship, many-to-many relationship, one-to-one relationship). Additionally, the container orchestration domain model 700 may include model components that are external domain model components 704 (e.g., 704-1 . . . 704-N) that represent external domains sharing the illustrated relationships to the other model components 702. These models determine the content that a user eventually sees on their screen.

To complement this flexible metamodel, the platform has schema-flexible stores to hold the actual data: The graph-based entity store and schema-flexible stores for metrics, events, logs and traces respectively. Thus, a customer who wants to extend the data model just modifies the corresponding model in the FMM and can immediately start populating the data stores with the respective data, without having to make changes to the data stores themselves.

Corresponding changes in the models/configurations driving the data processing pipeline will immediately start generating the data to populate the stores according to the model changes. An important feature of the extensibility platform is that it doesn't treat the respective models of a solution (FMM data model, data processing and consumption models) in isolation. These models refer to each other (e.g., a UI field will have a reference to the field in the data model it represents) and the integrity and consistency of these mutual references is tracked and enforced.

The extensibility platform herein is cloud-native, but at the same time, it allows every tenant to experience it as an individually configured application that reflects their specific business and angle of view. The tenants achieve this by selectively subscribing to solutions for each aspect of their business, and in some cases by even adding their own custom solutions.

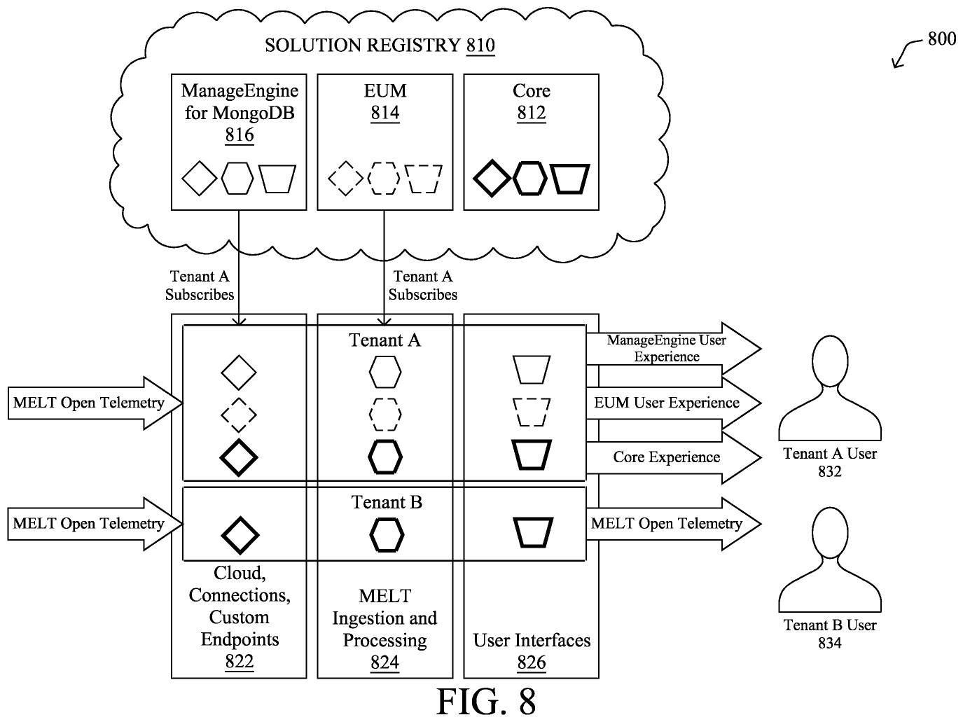

This is made possible by a sophisticated subscription and layering mechanism, illustrated in FIG. 8, illustrating tenant-specific behavior of the extensibility platform as a result of selective activation and layering of models. In this example mechanism 800, the solution registry 810 has three registered solutions, the platform core 812, End User Monitoring (EUM) 814 and a hypothetical third party solution, such as ManageEngine for MongoDB 816. Each of these solutions contains models for cloud connections and custom endpoints 822, MELT data ingestion and processing 824, and User Interfaces 826, respectively.

For each tenant (e.g., “A” or “B”), only the models that they are subscribed to are being used in the course of data collection, ingestion, processing and consumption, hence the experience of the tenant A user 832 in FIG. 8 is different from that of the tenant B user 834.

A particularly noteworthy characteristic of the platform herein is that these solutions don't necessarily live side-by-side. Rather, a solution can build on top of another solution, amend, and customize it. The final experience of tenant A user is therefore the result of the layering of the three subscribed solutions, where each can make modifications of the models of the layers below.

Notably, the scaling model of the extensibility platform herein is based on cells, where each cell serves a fixed set of tenants. Thus the solution registry and model stores of each cell keep the superset of all the solutions (and the corresponding artifacts) to which the tenants of the cell have subscribed. When a tenant subscribes to a solution, the solution registry checks whether that solution is already present in the cell. If not, it initiates a pull from the solution repository.

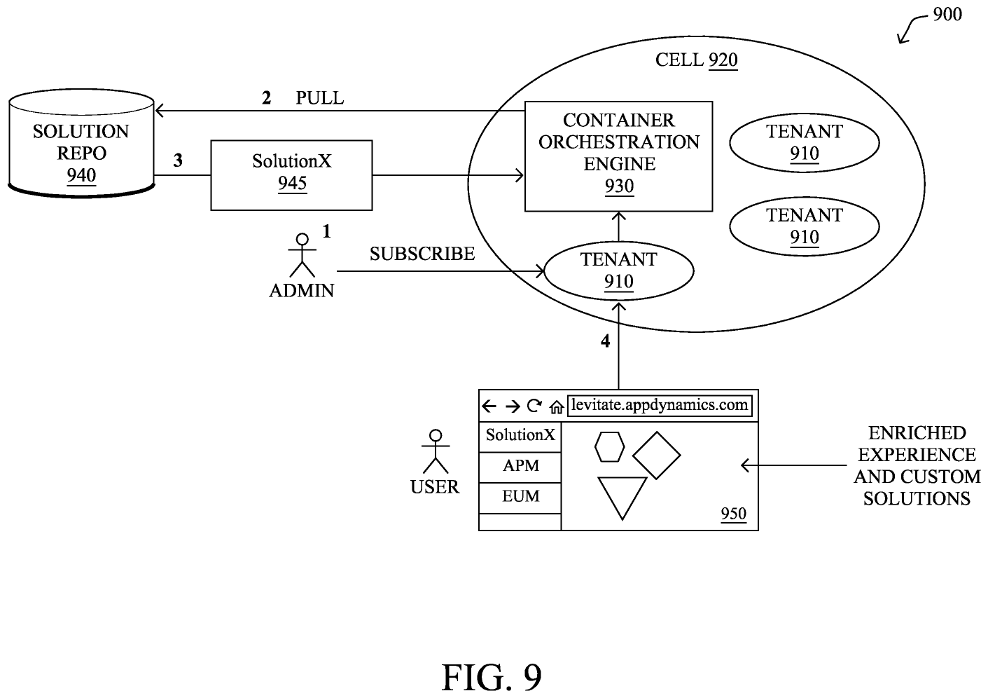

This concept is shown generally in FIG. 9, illustrating an example interplay 900 of tenant-specific solution subscription with cell management. In particular, tenants 910 exist within a cell 920, with an associated container orchestration engine 930 which pulls solutions 945 from a solution repository 940 (“solution repo”). A user interface 950 for the extensibility platform, such as an observability intelligence platform, can then illustrate an enhanced experience with custom solutions, accordingly.

Notably, in FIG. 9, when a solution is present in the cell (i.e., all its artifacts are present in the corresponding model stores), the solution is activated for the tenant. At that moment, the corresponding models/configurations will start taking effect.

Since the extensibility platform herein is a large distributed system, the models and configurations are not centrally stored but rather in multiple stores, each associated with one or more consumers of the respective model. Each of these stores is an instance of the same generic JSON store, and through routing rules, they are exposed as a single API with consistent behavior.

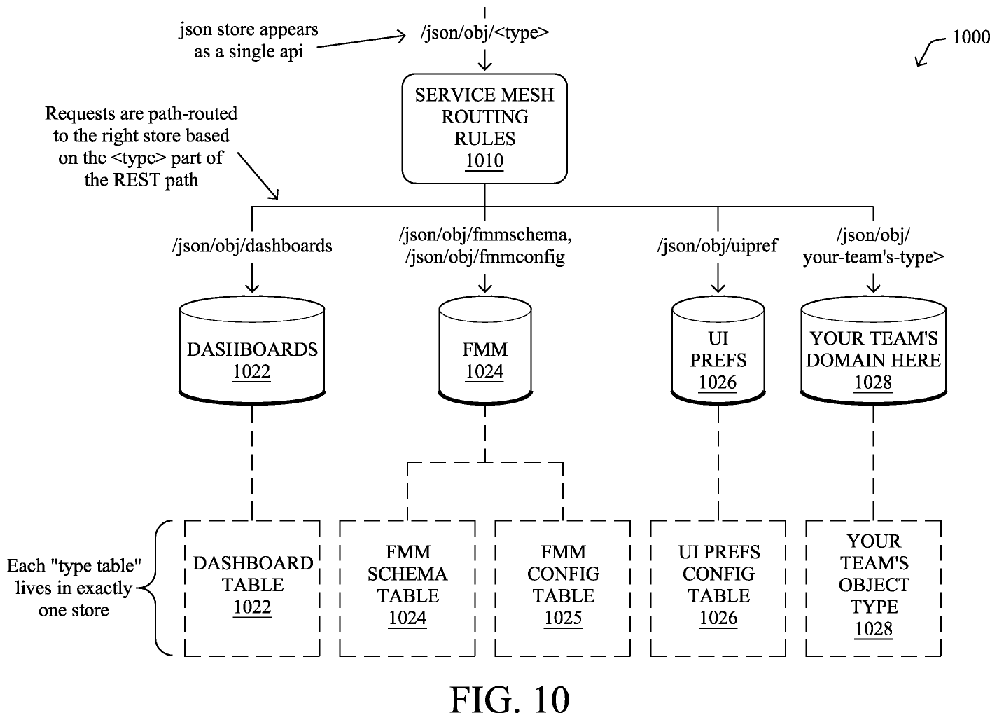

FIG. 10 illustrates an example 1000 of exposure of the different configuration stores as a single API. In particular, as shown, the JSON store appears as a single API and illustratively begins at service mesh routing rules 1010, where requests may be path-routed to the right store based on the <type>part of the REST path. The example stores may comprise dashboards 1022, FMM 1024, UI preferences 1026, custom stores 1028 (e.g., “Your Team's Domain Here”), and so on. From there, each “type table” lives in exactly one store. For instance, dashboard table 1032 (from dashboards 1022), FMM schema table 1034 or FMM config table 1035 (e.g., depending upon the access into FMM 1024), UI preferences config table 1036 from UI prefs 1026, and custom tables 1038 (e.g., from custom stores 1028, such as “Your Team's object type” from “Your Team's Domain Here”).

Regarding a configuration-driven data processing pipeline herein, a core feature of the extensibility platform herein is its ability to ingest, transform, enrich, and store large amounts of observed data from agents and OpenTelemetry (OT) sources. The raw data at the beginning of the ingestion process adheres to the OpenTelemetry format, but doesn't have explicit semantics. In a very simplified way, the raw data can be characterized as trees of key-value pairs and unstructured text (in the case of logs).

The purpose of the processing pipeline is to extract the meaning of that raw data, to derive secondary information, detect problems and indicators of system health, and make all that information “queryable” at scale. An important part of being queryable is the connection between the data and its meaning, i.e., the semantics, which have been modeled in the respective domain models. Hence the transformation from raw data to meaningful content can't be hard-coded, it should (e.g., must) be encoded in rules and configurations, which should (e.g., must) be consistent with the model of each domain.

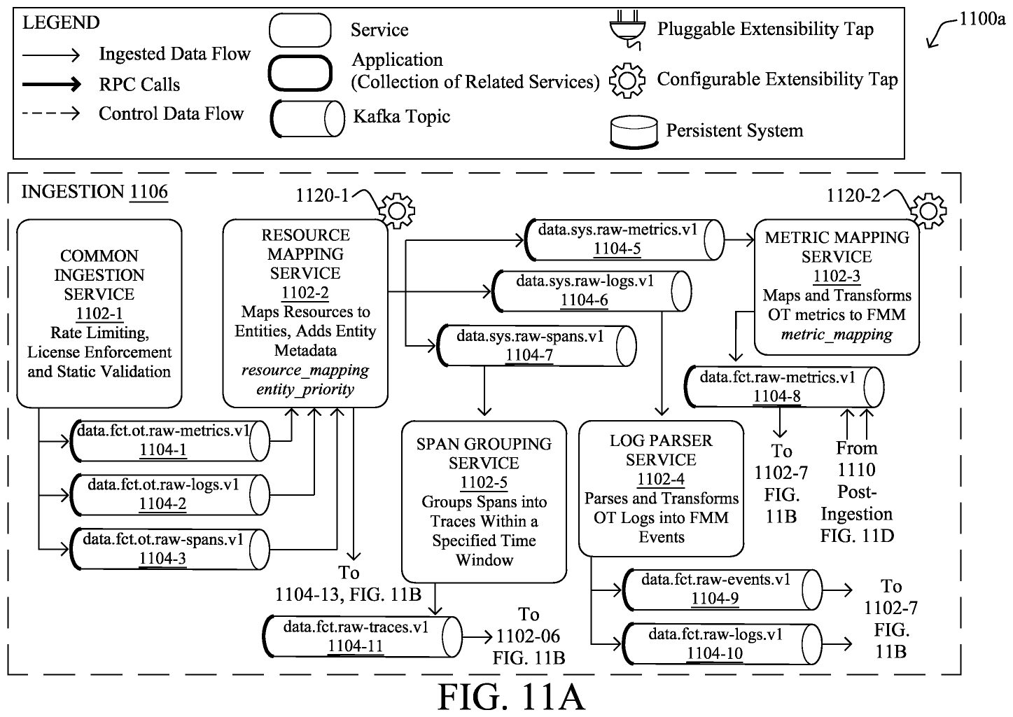

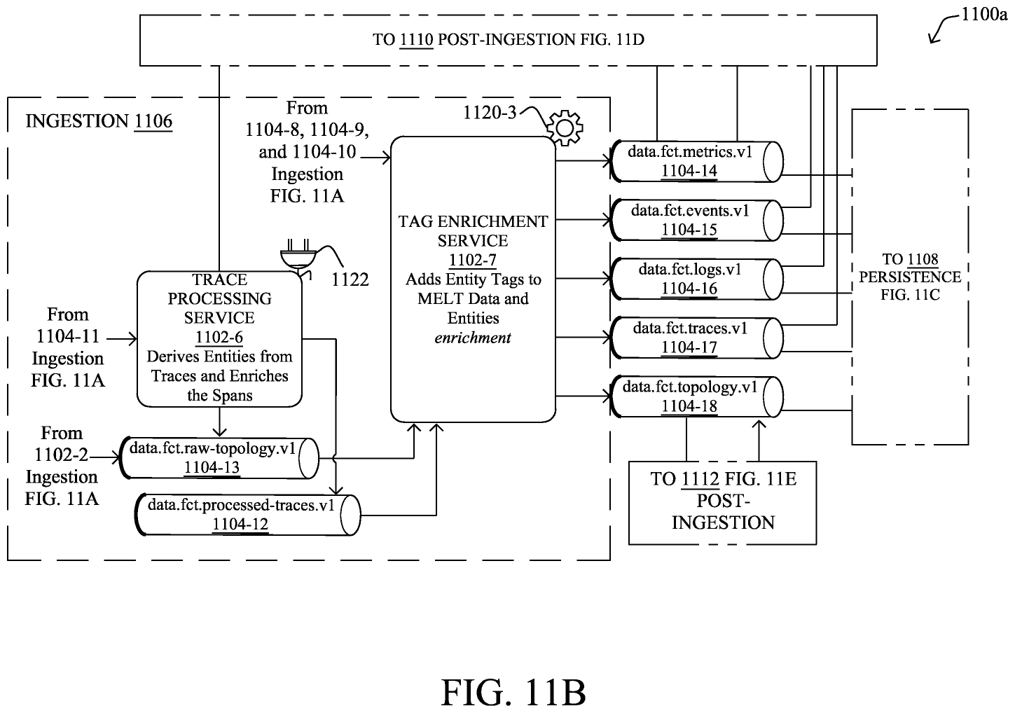

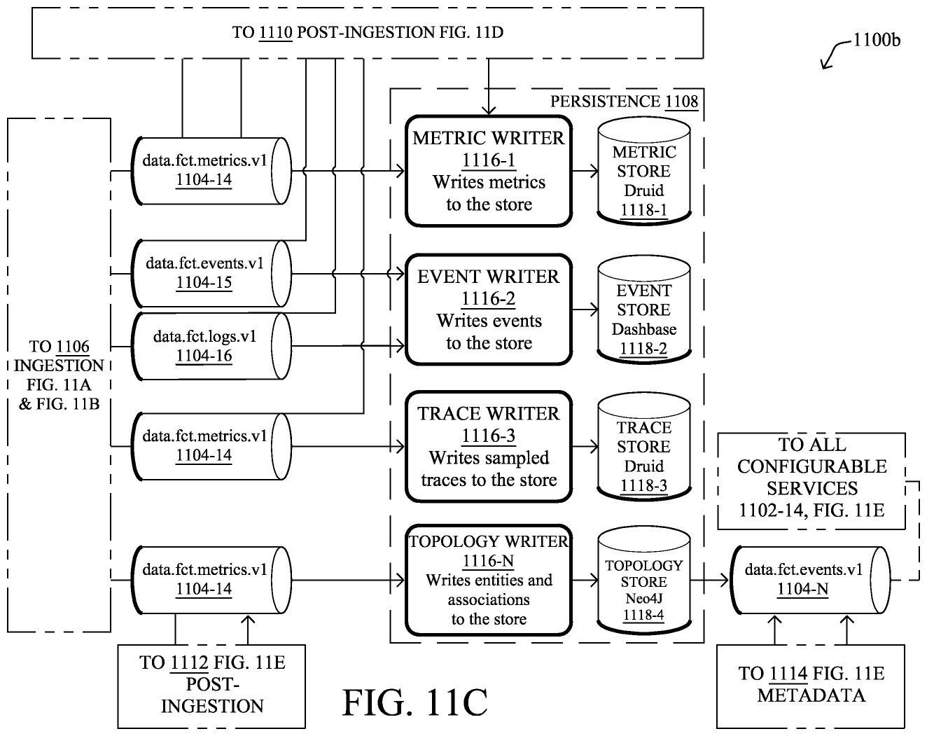

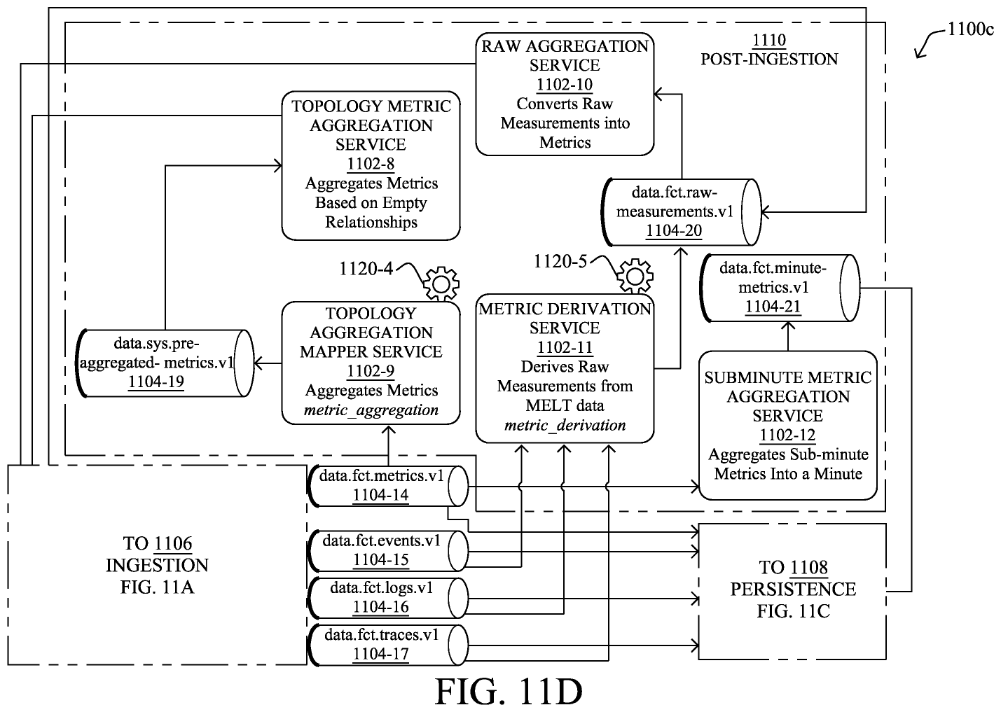

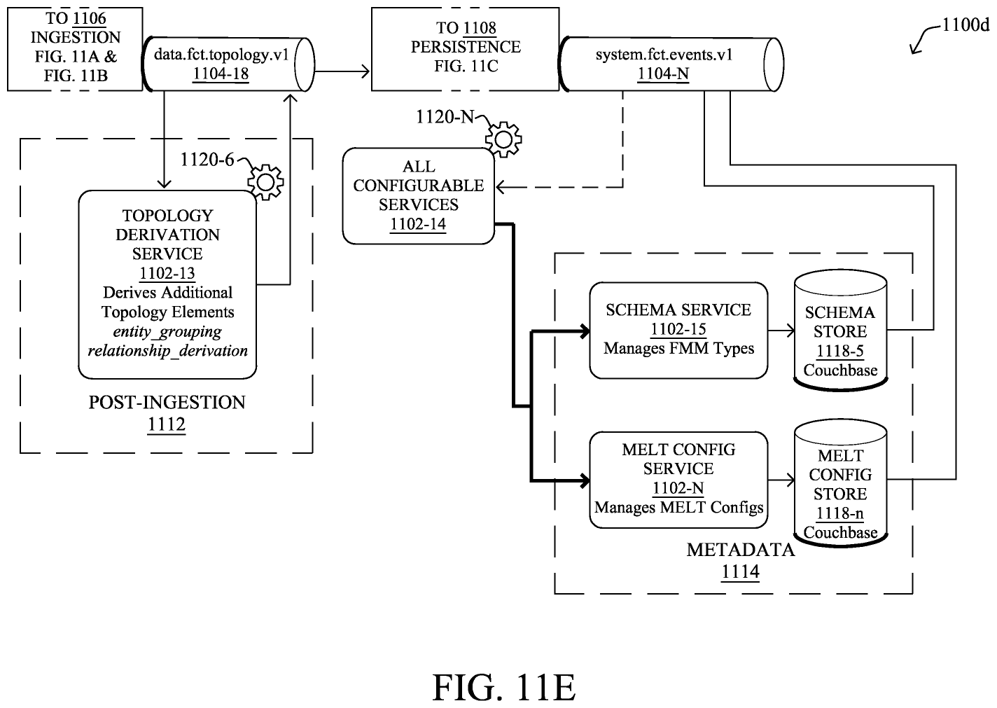

FIGS. 11A-11E illustrate an example of a common ingestion pipeline, e.g., the whole ingestion and transformation process. For clarity purposes, FIGS. 11A-11E each illustrate a respective portion of the entire pipeline. For example, FIGS. 11A-11B collectively illustrate a first quadrant 1100a including an ingestion portion 1106 of the pipeline, FIG. 11C illustrates a second quadrant 1100b including a persistence 1108 portion of the pipeline, FIG. 11D illustrates a third quadrant 1100c including a post-ingestion portion 1110 of the pipeline, and FIG. 11E illustrates a fourth quadrant 1100d including a second post ingestion portion 1112 and a metadata portion 1114 of the pipeline. Each of the quadrants may include transformation steps. These transformation steps may take the form of services 1102 (e.g., 1102-1 . . . 1102-N) or of applications 1116 (e.g., 1116-1 . . . 1116-N) which may include a collection of related services. Each of the quadrants may also include data queues 1104 (e.g., 1104-1 . . . 1104-N) (e.g., Kafka topics) that the steps subscribe to and feed into. Steps with a cogwheel symbol 1120 (e.g., 1120-1 . . . 1120-N) may be controlled by configuration objects, which means that they can be configurable extensibility taps adaptable to new domain models by the mere addition or modification of configurations. Steps with a plug symbol 1122 may include pluggable extensibility taps.

For example, the first quadrant 1100a may include common ingestion service 1102-1 (e.g., associated with rate limiting, license enforcement, and static validation), resource mapping service 1102-2 (e.g., associated with mapping resources to entities, adding entity metadata, resource_mapping, entity_priority, etc.), metric mapping service 1102-3 (e.g., associated with mapping and transforming OT metrics to FMM, metric_mapping, etc.), log parser service 1102-4 (e.g., associated with parsing and transforming logs into FMM events, etc.), span grouping service 1102-5 (e.g., associated with grouping spans into traces within a specified time window, etc.), trace processing service 1102-6 (e.g., associated with deriving entities from traces and enriching the spans, etc.), and/or tag enrichment service 1102-7 ((e.g., associated with adding entity tags to MELT data and entities, enrichment, etc.).

In addition, this quadrant may include data.fct.ot-raw-metrics.v1 data queue 1104-1, data.fct.ot-raw-logs.v1 data queue 1104-2, data.fct.ot-raw-spans.v1 data queue 1104-3, data.sys.raw-metrics.v1 data queue 1104-5, data.sys.raw-logs.v1 data queue 1104-6, data.sys.raw-spans.v1 data queue 1104-7, data.fct.raw-metrics.v1 data queue 1104-8, data.fact.raw-events.v1 data queue 1104-9, data.fct.raw-logs.v1 data queue 1104-10, data.fct.raw-traces.v1 data queue 1104-11, data.fct.processed-traces.v1 data queue 1104-12, data.fct.raw-topology.v1 data queue 1104-13, data.fct.metrics.v1 data queue 1104-14, data.fct.events.v1 data queue 1104-15, data.fct.logs.v1 data queue 1104-16, data.fct.traces.v1 data queue 1104-17, and/or data.fct.topology.v1 data queue 1104-18.

The second quadrant 1100b may include metric writer application 1116-1 (e.g., associated with writing metrics to the metric store 1118-1 (e.g., druid)), event writer application 1116-2 (e.g., associated with writing events to the event store 1118-2 (e.g., dashbase)), trace writer application 1116-3 (e.g., associated with writing sampled traces to the trace store 1118-3 (e.g., druid)), and/or topology writer 1116-N (e.g., associated with writing entities and associations to the topology store 1118-4 (e.g., Neo4J). Additionally, this quadrant may include system.fct.events.v1 data queue 1104-N.

The third quadrant 1100c may include topology metric aggregation service 1102-8 (e.g., associated with aggregating metrics based on entity relationships, etc.), topology aggregation mapper service 1102-9 (e.g., associated with aggregating metrics, mertic_aggregation, etc.), raw measurement aggregation service 1102-10 (e.g., associated with converting raw measurements into metrics, etc.), metric derivation service 1102-11 (e.g., associated with deriving measurements from melt data, metric_derivations, etc.), and/or sub-minute metric aggregation service 1102-12 (e.g., associated with aggregating sub-minute metrics into a minute, etc.). Additionally, this quadrant may include data.sys.pre-aggregated-metrics.v1 data queue 1104-19, data.fct.raw-measurements.v1 data queue 1104-20, and/or data.fct.minute-metrics.v1 data queue 1104-21.

The fourth quadrant 1100d may include topology derivation service 110-13 (e.g., associated with deriving additional topology elements, entity_ grouping, relationship_derviation, etc.), all configuration services 1102-14, schema service 1102 (e.g., associated with managing FMM types), and/or MELT config service 1102-N (e.g., associated with managing MELT configurations, etc.). In addition, this quadrant may include schema store 1118-5 (e.g., couchbase) and/or MELT config store 1118-N (e.g., couchbase).

Other components and interconnections/relationships may be made in a common ingestion pipeline architecture. The views and products illustrated in FIG. 11A-11E are shown herein merely as example implementations that may be used to provide and/or support one or more features of the techniques herein.

A typical example of rule-driven transformation is the mapping of the Open Telemetry Resource descriptor to an entity in the domain model. The Resource descriptor contains key-value pairs representing metadata about the instrumented resource (e.g., a service) that a set of observed data (e.g., metrics) refers to. The task of the Resource Mapping Service is to identify the entity, which the Resource descriptor describes, and to create it in the Topology Store (which stores entities and their relations) if it isn't known yet.

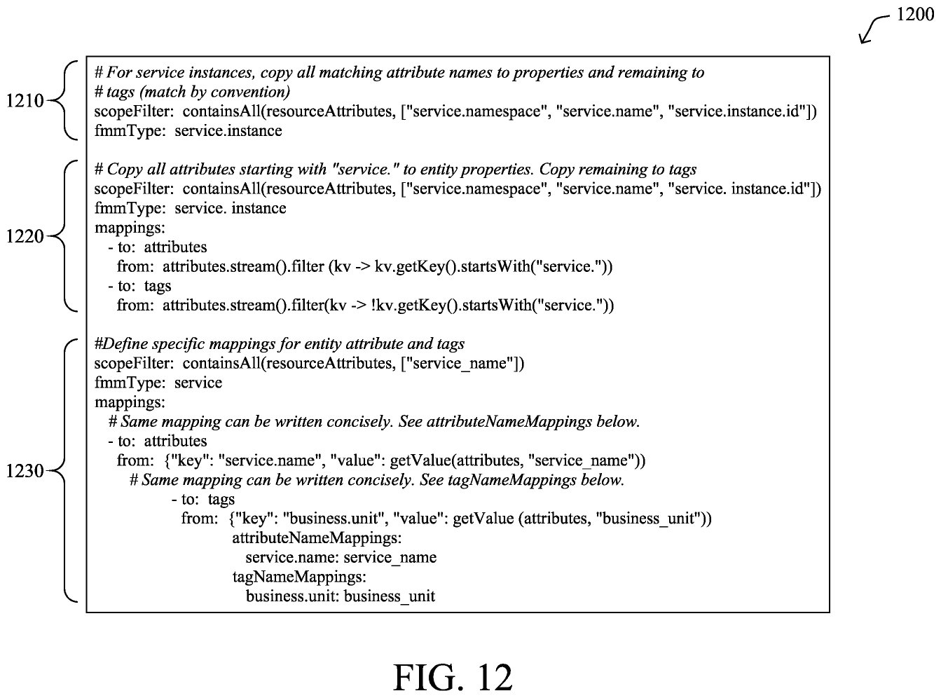

FIG. 12 illustrates an example of resource mapping configurations 1200. In particular, the three specific examples for a resource mapping configuration are, essentially:
1210: For service instances, copy all matching attribute names to properties and remaining to tags (match by convention);
1220: Copy all attributes starting with “service.” To entity properties—copy remaining to tags;
1230: Define specific mappings for entity attribute and tags.

As shown in FIG. 12, an expression “scopeFilter” is used to recognize the input (i.e., records not matching the scope filter are ignored) and “fmmType” assigns an entity type to the resource if it is recognized. The mappings rules then populate the fields of the entity (as declared in the domain model) with content derived from the OpenTelemetry content. Thus the resource mapping configuration refers to, and complements, the domain model, enabling individual tenants to observe and analyze the respective entities in their own system landscape regardless of whether the extensibility platform (e.g., the observability intelligence platform above) supports these entity types as part of the preconfigured (“out of the box”) domain models.

The totality of these models and configurations can be considered as one composite multi-level model. Composite in the sense that it has parts coming from different organizations (e.g., the observability intelligence platform distributor, customers, third parties, etc.) and multi-level in the sense that the artifacts drive the behavior of different parts of the whole system, e.g., ingestion, storage, User Interface, etc. Since artifacts refer to each other both across origin and across technical level, the reliable operation of the system heavily relies on the JSON store's ability to understand and enforce the consistency of these references.

For the Trace Processing Service, even more flexibility is required. What is shown as a single box in the diagram is actually itself a workflow of multiple processing steps that need to be dynamically orchestrated depending on the respective domain.

The description below provides greater details regarding the Configuration-Driven Data Processing Pipeline.

Regarding embedding custom container images and FaaS, in accordance with the techniques herein, especially in the complex trace processing workflows, but also in pre-ingestion processing (such as the enrichment of observed data with geographic information derived from IP addresses), some required transformations are too sophisticated for generic rule-driven algorithms. In such cases, the customer must be able to provide their logic as a function that can be executed as a service (e.g., a FaaS) or even a container image exposing a well-defined service interface.

Note that where custom functions are running external to the extensibility platform, the corresponding secrets to access them need to be made available to calling services.

Another security-related problem coming with custom services is that their access may need to be restricted based on user roles. One solution to this is to use custom representational state transfer (REST) endpoints and extensible role-based access control (RBAC) for an extensibility platform.

The extensibility platform herein also illustratively uses a graph-based query engine. In particular, an important precondition for the configuration-driven consumption of customer-specific content is the ability to query data via a central query engine exposing a graph-based query language (as opposed to accessing data via multiple specific services with narrow service interfaces).

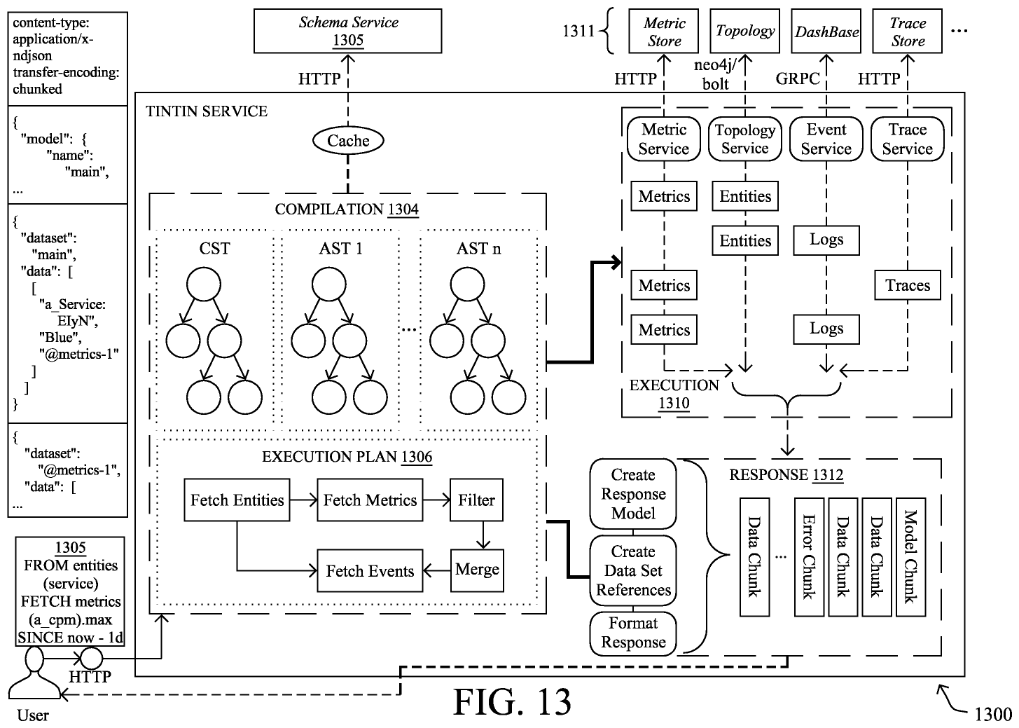

FIG. 13 illustrates an example of a design of a Unified Query Engine (UQE) 1300. The Unified Query Engine 1300, in particular, provides combined access to:
Topology (Entities and their relationships);
Metrics;
Events;
Logs; and
Traces.

The Unified Query Engine 1300 may provide the combined access by receiving a fetch request 1302, performing compilation 1304 and determining execution plan 1306. In addition, Unified Query Engine 1300 may execution 1310 and response 1312. Results of performing compilation 1304 and/or execution plan 1306 may be cached with schema service 1305. Results of execution 1310 may be stored in observability stores 1311 which may include a metric store, a topology store, a DashBase store, a trace store, etc. For example, the topology data may be stored in a graph database, and the unified query language (UQL) may allow the platform to identify sets of entities and then retrieve related data (MELT) as well as related entities. The ability to traverse relationships to find related entities enables the application of graph processing methods to the combined data (entities and MELT).

The extensibility platform herein also uses a Configuration-Driven User Interface. In order to allow customers and third parties to create domain-specific Uis without deploying code, the UI is built according to the following principles:
1. No domain knowledge is hard-coded into any UI components.
   In particular, no references whatsoever to FMM model content occur in the UI code.
2. Domain knowledge is modeled into UI configurations.
   The appearance of the UI, as far as it is domain-specific, is determined by declarative configurations for a number of predefined building blocks.
3. Uniform modeling approach, reusable configurations.
   Regardless of the page context (Dashboard, Object Centric Pages (OCP), etc.), the same things are always configured in the same way. Existing configurations can be reused in different contexts. Reusable configurations declare the type of entity data they visualize, and reuse involves binding this data to a parent context.
4. Dynamic selection of configurations.
   On all levels, configurations can be dynamically selected from multiple alternatives based on the type (and subtype) of the data/entity to which they are bound. The most prominent example is the OCP template, which is selected based on the type of the focus entity (or entities).
5. Nesting of configurable components, declarative data binding.
Some components can be configured to embed other components. The configurations of these components declare the binding of their child components to data related to their own input. No extension-specific hard-coded logic is required to provide these components with data. This gives third parties enough degrees of freedom to create complex custom visualizations.
6. Limited Interaction Model.
   In contrast to the visualization, third parties have limited ways to influence the behavior of the application. The general Human Computer Interaction mechanics remain the same for all applications. For example, it is possible to select the “onclick” behavior for a component out of a given choice, e.g., drilldown, set filter, etc.

The extensibility platform herein also uses a Cell-based Architecture. That is, the extensibility platform herein is a cloud-native product, and it scales according to a cell-based architecture. In a cell architecture, in particular, the “entire system” (modulo global elements) is stamped out many times in a given region. A cell architecture has the advantages of limiting blast radius (number of tenants per cell affected by a problem), predictable capacity and scalability requirements, and dedicated environments for bigger customers.

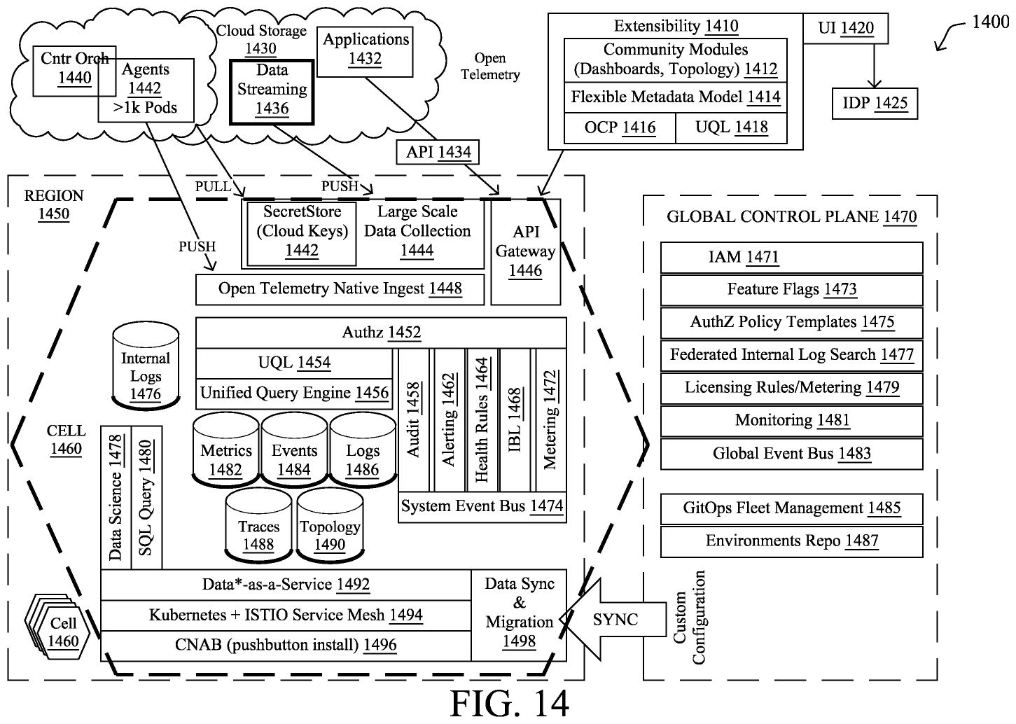

FIG. 14 illustrates an example of a deployment structure of an observability intelligence platform in accordance with the extensibility platform herein, and the associated cell-based architecture. As shown in extensibility platform diagram 1400, an extensibility platform 1410 has community modules 1412 (dashboards, topology), a flexible meta model (FMM) 1414, an OCP 1416, and a UQL 1418. A UI 1420 interfaces with the platform, as well as an IDP (Identity Provider) 1425. Cloud Storage/Compute 1430 has various Applications 1432 (and associated APIs 1434). As well as Data Streaming services 1436. A Container Orchestration Engine 1440 (e.g., K8s) may have numerous deployed Agents 1442. The MELT data is then pushed or pulled into a particular Region 1450 and one or more specific cells 1460. Each cell may contain various features, such as, for example:
SecretStore (cloud keys) 1442, Large Scale Data Collection 1444
API Gateway 1446
Open Telemetry Native Ingest 1448
AuthZ (authorization) 1452
UQL 1454
Unified Query Engine 1456
Audit 1458
Alerting 1462
Health Rules 1464
IBL 1468
Metering 1472
System Event Bus 1474
Internal Logs 1476
Data Science 1478
SQL Query 1480
Metrics 1482
Events 1484
Logs 1486
Traces 1488
Topology 1490
data-as-a-service 1492
Kubernetes+ISTIO Service Mesh 1494
CNAB (pushbutton install) 1496
Data Sync & Migration 1498
Etc.

Global control plane 1470 may also contain a number of corresponding components, such as, for example:
IAM (Identity and Access Management) 1471
Feature Flags 1473
Authz Policy Templates 1475
Federated Internal Log Search 1477
Licensing Rules/Metering 1479
Monitoring 1481
Global event bus 1483
GitOps fleet management 1485
Environments Repository 1487
Etc.

Note that the global control plane 1470 passes Custom Configurations to sync into the cell 1460 (data sync & migration), as shown.

Note that a specific challenge in certain configurations of this model may include the balancing of resources between the multiple tenants using a cell, and various mechanisms for performing service rate limiting may be used herein.

Another specific challenge in this model is in regard to disaster recovery. Again, various mechanisms for disaster recovery may be used herein, as well.

The techniques described herein, therefore, provide for an extensibility platform, and associated technologies. In particular, the techniques herein provide a better product to customers, where more features are available to users, especially as feature development is offloaded from a core team to the community at-large. The extensibility platform provides a clean development model for first party apps (e.g., EUM, Secure App, etc.) and second party apps (e.g., observability, etc.), enabling faster innovation cycles regardless of complexity, particularly as there is no entanglement with (or generally waiting for) a core team and roadmap. The techniques herein also enable a software as a service (SaaS) subscription model for a large array of features.

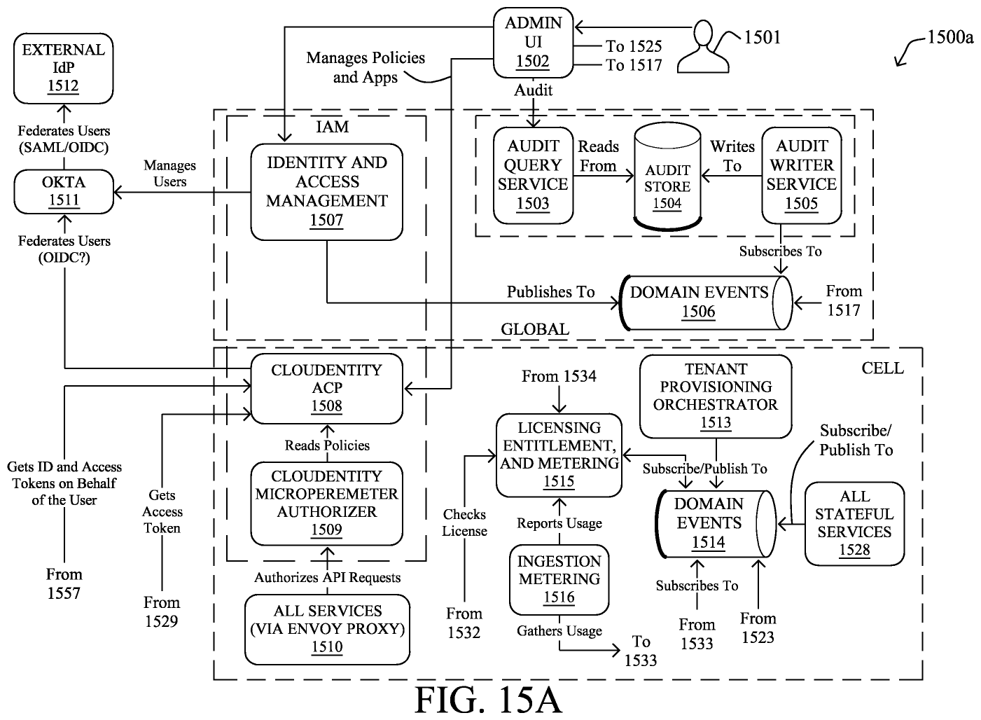

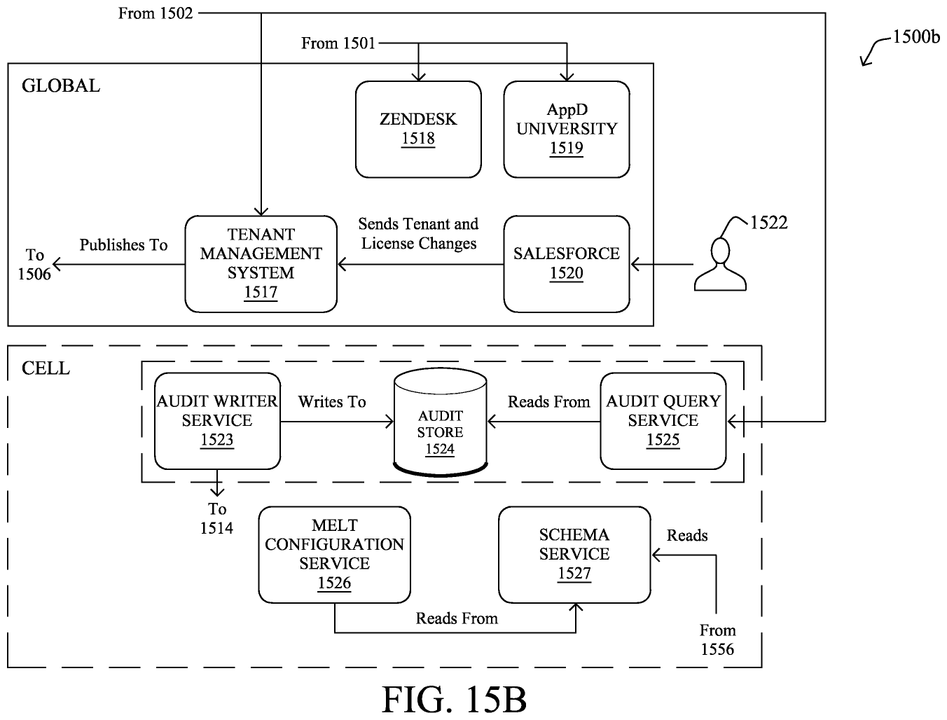

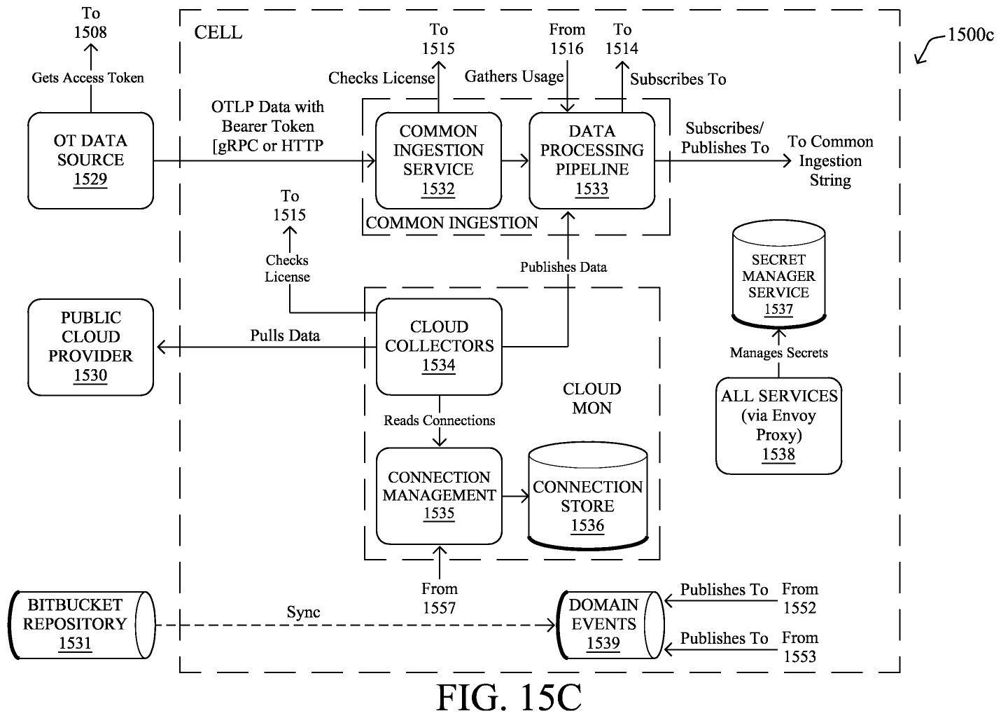

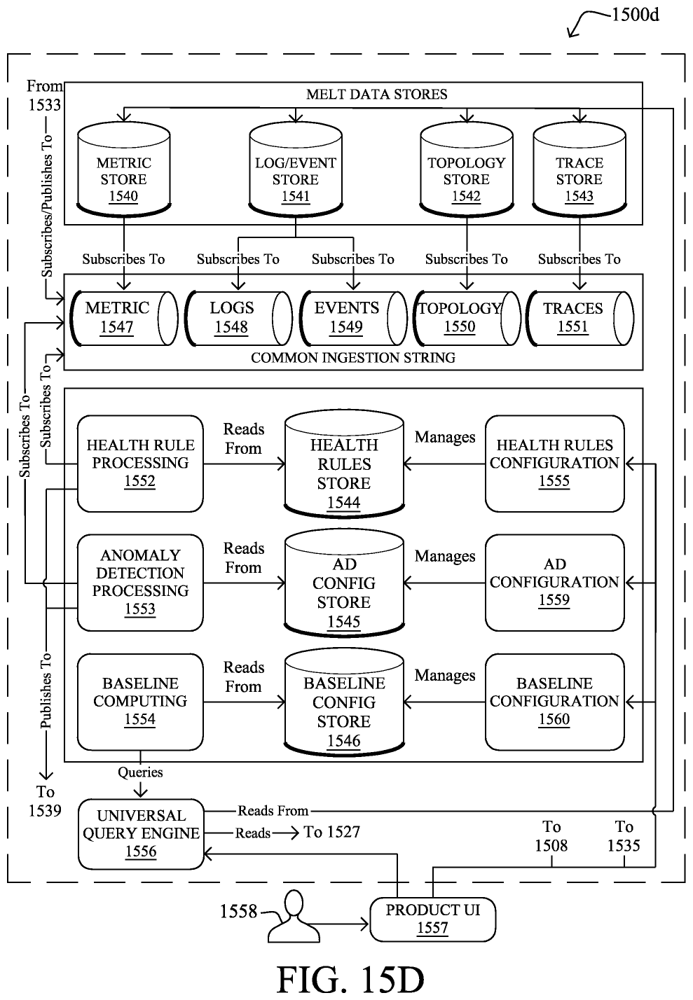

FIGS. 15A-15D illustrate another example of a system for utilizing an extensibility platform. For clarity purposes, FIGS. 15A-15D each illustrate a respective quadrant of the entire system. For example, FIG. 15A illustrates a first quadrant 1500a of the system, FIG. 15B illustrates a second quadrant 1500b of the system, FIG. 15C illustrates a third quadrant 1500c of the system, and FIG. 15D illustrates a fourth quadrant 1500d of the system.

The system may receive input from a customer and/or admin 1501 of the system. Via an admin user interface 1502. The system may include a global portion. This global portion may include an audit component. The audit component may include an audit query service 1503 that may allow the querying of an audit log, an audit store 1504 (e.g., dashbase), and/or an audit writer service 1505 that may populate the audit store 1504. In addition, the global portion may include Zendesk 1518 or another component that will support requests, “AppD university” 1519 or another component that will manage training material and courses, salesforce 1520 or another component that allows management of procurement and billing, and/or a tenant management system 1517 for managing tenant and license lifecycle. An “AppD persona” 1522 may interact with salesforce 1520. The global portion may additionally include domain events 1506 for global domain events and identity and access management 1507 that facilitates management of users, application, and their access policies and configure federation.

The system may also include external IdP 1512 which may include a SAML, OpenIS or Oauth2.0 compliant identity provider. The system may include Okta 1511 which may include an identity provider for managed users. In addition, the system may interface with OT data source 1529 which may act as an OT agent/collector or a modern observability agent. In various embodiments, the system may interface with public cloud provider 1530 such as AWS, Azure, GCP, etc. The system may also include BitBucket repository 1531 to produce configs and/or models as code.

In addition to the global portion, the system may also include a cell portion. The cell portion may include a cloudentity ACP 1508 which may operate as an openID provider, perform application management, and/or perform policy management. Further, the cell portion may include cloudentity microperemeter authorizer 1509 for policy evaluation. Furthermore, the cell may include all services 1510 via envoy proxy.

The cell portion may include a second audit component which may include a second audit query service 1525, a second audit store 1524, and/or a second audit writer service 1523. The cell portion may also include a second domain event 1514 for cell domain events. Further, the cell portion may include a tenant provisioning orchestrator 1513, an ingestion meter 1516 that meters ingestion usage, and/or a licensing, entitlement, and metering manager 1515 that facilitates queries of licensing usage, performs entitlement checks, and/or reports on usage. Again, the cell portion may include all stateful services 1528.

The cell portion may include a common ingestion component. The common ingestion component may include data processing pipeline 1533 which may validate and transform data. Data processing pipeline 1533 may also enrich entities and MELT based on configurations. The common ingestion component may also include common ingestion service 1532, which may authenticate and/or authorize requests, enforces licenses, and/or validate a payload.

Moreover, the cell portion may include a common ingestion stream component. The common ingestion stream component may include metrics 1547 (e.g., typed entity aware metrics), logs 1548 (e.g., entity aware logs), events 1549 (e.g., typed entity aware events), topology 1550 (e.g., typed entities and associations), and/or traces 1551 (e.g., entity aware traces). In addition, the cell portion may include a MELT data stores components that includes metric store 1540 (e.g., druid), log/event store 1541 (e.g., dashbase), topology store 1542 (e.g., Neo4j), and/or trace store 1543 (e.g., druid).

In various embodiments, the cell portion of the system may include a cloudmon component, which may include cloud collectors 1534 that collect data from public cloud providers 1530. Additionally, the cloudmon component may include connection management 1535, which may facilitate management of external connections and their credentials. In some instances, the cloudmon component may include a connection store 1536 (e.g., 39ostgreSQL).

The cell portion may also include an alerting component. The alerting component may include a health rule processor 1552 for evaluating health rules and generating entity health events. Further, the alerting component may include a health rule store 1544 (e.g., mongo DB) and/or a health rule configuration 1555 that facilitates the management of health rules. Likewise, the altering component may include an anomaly detection processor 1553 to detect anomalies and/or publish their events, an anomaly detection config store 1545 (e.g., mongoDB), and/or an anomaly detection configuration 1559 that facilitates enabling/disabling/providing feedback for anomaly detection. The alerting component may also include a baseline computer 1554 for computing baselines for metrics, a baseline config store 1546 (e.g., mongoDB), and/or a baseline configuration 1560 to facilitate configuration of baselines.

The cell portion may include a secret manager service 1537 (e.g., HashiCorp Vault) exposed to all services 1538 via envoy proxy. The cell portion may include a third domain event 1539 for cell domain events. In addition, the cell portion of the system may include a universal query engine 1556 that may expose a query language for ad-hoc queries. An end user 1558 may interface with universal query engine 1556 over a product user interface 1557. In addition, the universal query engine 1556 may read from schema service 1527. Schema service 1527 may facilitate querying and management of FMM types. Furthermore, MELT configuration service 1526 may perform configuration of data processing pipeline 1533.

Other components and interconnections/relationships may be made in an example extensibility platform herein, and the views and products illustrated in FIG. 15A-15D are shown herein merely as example implementations that may be used to provide and/or support one or more features of the techniques herein.

### Configuration-Driven Query Composition for Graph Data Structures

The techniques herein extend and/or support the extensibility platform described above by defining a configuration-driven query composition for graph data structures.

In traditional application software, the schema of the data and the presentation of the data in the User Interface have been hard-coded, i.e. changes in the data structure or UI required releasing a new version of the software.

Model-driven development has reduced the amount of work required for such changes. Early model-driven approaches still generated code that needed to be built and released. But along with the increasing popularity of schema-flexible data stores (Graph stores, NoSQL databases), the modification of business applications by mere model (configuration) changes has become the preferable option. In this approach, generic code interprets these configurations to produce the desired behavior and User Interface of the application, so that the software can be adapted to individual customer needs without any change to the code itself.

A field where configuration-driven user interfaces are very common is the provision of customizable dashboards. A dashboard consists of multiple widgets each displaying a specific piece of data with a specific way of rendering. Thus the configuration of such a widget usually consists of three parts:
A query to the backend providing the required data
Data binding and transformation instructions to convert the data retrieved from the backend to the input the generic widget expects
Visualization options defining the presentation of the data in the widget

Typically, all the widgets on a dashboard are independent of each other. Making them behave in a coherent manner (e.g. applying a common filter to all of them) is hard to achieve without hard-coded logic, because it requires generic code to understand the structure of the individual queries well enough to manipulate each of them in the right way.

For this reason, the approach generally taken for dashboards is not suitable for UI pages supporting specific activities: Such pages typically focus on one specific set of data and show related information from different angles of view. Interaction with one of the UI components (such as selection, filtering or highlighting) needs to affect the display of other components on the same page.

Another drawback of the usual dashboard approach is the fact that separate queries are sent for each of the widgets, even when there are large overlaps between the data required for each of them. That can create a high load for the backend and result in bad user experience due to long loading times.

In hard-coded applications, these problems are usually solved by means of a composition hierarchy, where logic is attached to each UI component in this hierarchy and the logic of a parent component manages the coherent behavior of all its children. It also drives the composition of efficient queries and distribution of result data to the individual widgets. Such logic is often referred to as “glue code”.

The absence of such glue code in a purely configuration-driven approach makes it difficult to provide fully customizable User Interfaces for specific activities (as opposed to dashboards).

According to the configuration-driven query composition for graph data structures for the extensibility platform herein, therefore, all data structures can be seen as graphs of entities, where each entity has properties and relationships to other entities. An activity-specific User Interface typically displays one subgraph centered around a currently selected set of entities (the scope).

Also, the composition tree of the components is typically reflected by one or multiple tree structures embedded in said subgraph. In other words, the data each UI component binds to is typically related to the data its parent component binds to, and the relationship between these two pieces of data can be expressed by a data path from parent to child.

Because that data path is relative, and doesn't require knowledge of the absolute definition of information represented by the parent component, it is possible to dynamically configure hierarchies of components and then derive the full structure of the subgraph required to render these components from the data paths. Combined with the knowledge of the set of entities bound to the root component (the scope), this structure can then be translated into an optimized query with no redundant requests, which provides the data required to render the UI.

In combination with a backend providing some form of query language that supports dynamically querying graph structures, new activity specific Uis can be developed by mere configuration without making any changes to frontend or backend code.

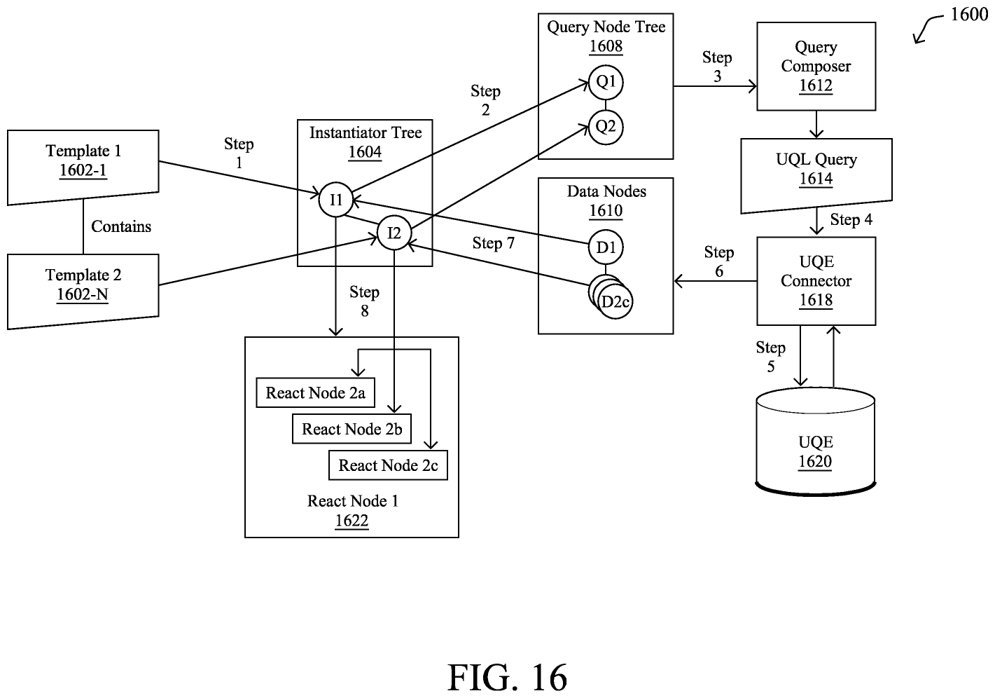

In detail, the techniques herein comprise the following steps, with reference to FIG. 16 which illustrates an example diagram 1600 depicting the configuration-driven query composition for graph data structures herein:
Implementing hard-coded widgets for configurable atomic building blocks (labels, charts) and nestable containers, which each implement an interface for the dynamic query composition
Defining hierarchies of these building blocks in configurations, where child components typically declare the data path tying the data to be rendered in the component to the data associated with its parent component. Illustrated as Step 1, these operations may involve templates 1602 (e.g., 1602-1 . . . 1602-N) and instantiator tree 1604.
Recursively traversing the resulting tree of configured components, where the hard-coded building blocks underpinning each component add the information requests needed for the particular configuration to a shared query tree. Illustrated as Step 2, these operations may involve query node tree 1608.
Translating the resulting query tree (which represents the required subgraph of data) into a query according to the backend's query language (Illustrated as Step 3 and Step 4, these operations may involve query composer 1612, UQL query 1614, and/or UQE connector 1618) and sending the request to the backend (Illustrated as Step 5, these operations may involve UGE 1620).
Translating the query result into a data tree that is recursively passed down from the top component to all children. Illustrated as Step 6 and Step 7, these operations may involve data nodes 1610 and insantiator tree 1604.
Rendering the UI with the obtained data. Illustrated as Step 8, these operations may involve react node 1622.

Particularly regarding template-based UI Extensibility, all screens are rendered by atomic (hard-coded) UI building blocks which can be dynamically configured and arranged. Atomic building blocks can be simple (such as a text field or chart) or composite (such as a Relationship map and even the Observe page), and can contain parts that are dynamically populated by other building blocks.

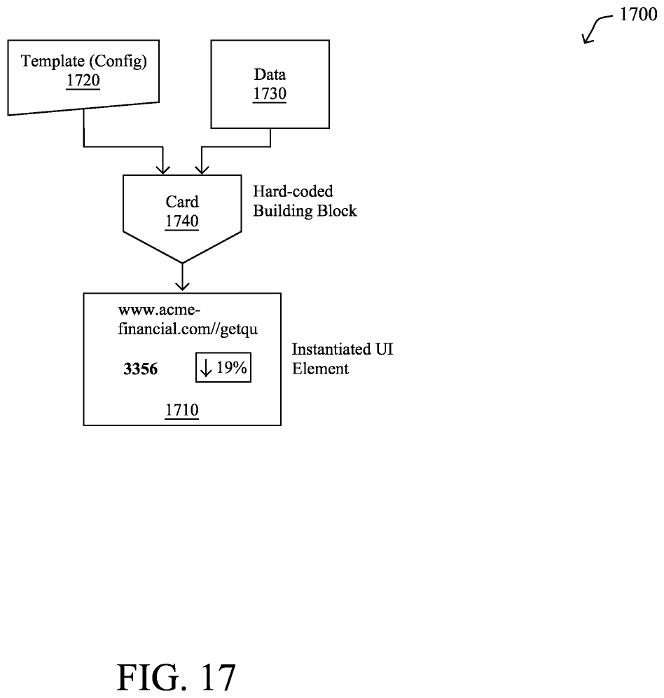

The configuration of a composite building block is called template. In order to instantiate a UI element, the hard-coded building block combines the supplied template and data to generate a DOM element. See, for example, FIG. 17, which illustrates an example 1700 of building an instantiated UI element 1710 from a template 1720 and data 1730 (e.g., through a card, a hard-coded building block).

Templates for composite building blocks specify the templates and data for the contained child elements. Apart from that, each building block has its own configuration options and rules—it can give very few or many degrees of freedom. Interaction is hard-coded for each building block but can take hints from the configuration.

Most templates are designed to visualize entities or MELT data of specified types, and they declare the respective type in their metadata (‘appliesTo’). Such templates can then be dynamically selected based on the data to be displayed. The dynamic selection of templates allows to specify rather generic fallback templates for supertypes of entities and more expressive templates for some of the subtypes. It also means that no new templates are required when a new entity type is introduced by an extension if it is a subtype of an existing type.

Other templates specify the content they visualize themselves, e.g., the FROM part of a UQL query. These templates are typically the configurations of root-level UI components, such as the Observe page.

Notably, a “relationship map” is an atomic block, its configuration defines the domain-specific segments with paths for each relationship and the health attribute to evaluate in order to group into red/green bubble. The out-of-the-box configuration can be:
kind: RelationshipMapConfig
namespace: core
name: serviceRelationshipMap
target: apm: service
segments:
   domain: APM
      relationships:
   name: Services
      entityType: apm:service
         path: “.”
      healthAttribute: hs:health
   name: Instances
      entityType: apm:ServiceInstance
      path: apm: serviceToInstance
      healthAttribute: hs:health
   name: Business Transactions
      entityType: apm:BusinessTransaction
      path: apm:serviceToBT
      healthAttribute: hs:health
   name: Service Endpoints
      entityType: apm:ServiceEndpoint
      path: apm:serviceToSEP
      healthAttribute: hs:health
   domain: k8s
      relationships:
   name: Pods
      entityType: k8s:pod
      path: apm:serviceToInstance->k8s:instanceToPod
      healthAttribute: hs:health
   name: Hosts
      entityType: k8s:node
      path: apm:serviceToInstance->k8s:instanceToPod->k8s:podToNode
      healthAttribute: hs:health

A new domain could add new segments to the relationship map by applying a patch:
kind: ui-extension
namespace: eum
extends: core: serviceRelationshipMap
patch:
   op: add
      path: “/segments/0”
      value:
         domain: EUM
         relationships:
         name: Steps
         entityType: eum:Step
         path: apm:serviceToBT->eum:BTToStep
         healthAttribute: eum:health
      . . .

The “topology map” is another primitive, however it can embed template-based components for the nodes. If ‘connectionType’ is specified, the map layout algorithm uses the respective entities as associations (and renders them as labels):
kind: TopologyMapConfig
namespace: apm
name: Flowmap
target: apm: service
layoutStrategy: sequential
connectionType: apm:interaction
path: apm:out[apm:interaction]->apm:to
nodeTemplate: circle
connectionTemplate: compact
edgeWidthAttribute: apm:CPM
bounded: true

The metric “Card” for CPM is a flexible primitive that allows recursive composition of “elements” which can be cards, charts, divs, images. The input of a card (similar to the props in React) always has a prop ‘data’, which is an entity of one of the types specified in ‘appliesTo’. The elements can map attributes, metrics or related entities of the ‘data’ entity to child elements. Here, the metric ‘apm:cpm’ is mapped to a chart element that uses a metric as input.
kind: Card
namespace: apm
name: chart CPM timeline
target:
   apm: service
   apm:interaction
layout: column
elements:
   type: label
      text: CPM
      font-size: 20px
   type: chart
      data: .metric.apm:cpm
      chartType: metric-line
      x-min: context.time.start
      x-max: context.time.end

An OCP config is a list of OCP elements and their respective configurations. The OCP itself is a hard-coded part of the observe page.
kind: OCPConfig
namespace: apm
name: serviceOCP
target: apm: service
elements:
   type: topologyMap
      config: apm:Flowmap
   type: card
      config: apm:chart_CPM_timeline
   type: card
      config: apm:chart_ART_timeline
   type: card
      config: apm:chart_EPM_ timeline

The observe page config is a “root element” that specifies configurations and data binding for its predefined components:
kind: ObservePageConfig
namespace: core
name: defaultObservePage
query:
   from: entity(apm:service)
   conditions:
      attribute(environment)=‘PROD’
   relationshipMap: core: serviceRelationshipMap
   ocp: apm:serviceOCP

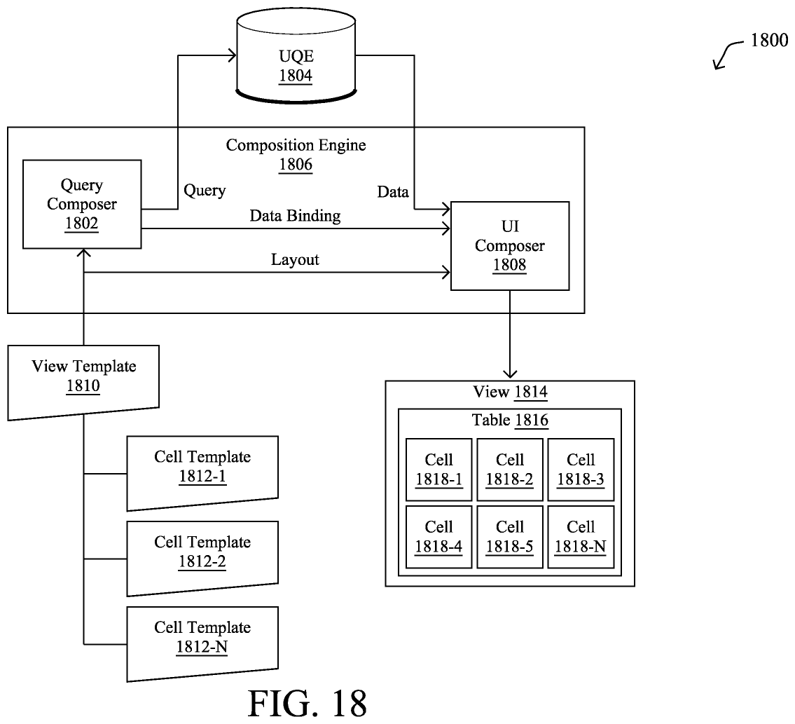

FIG. 18 illustrates an example data flow 1800 and rendering of the example herein. The data flow 1800 is illustrated as occurring across a composition engine 1806. Specifically, view template 1810 and/or cell templates 1812 (e.g., 1812-1 . . . 1812-N) are input to query composer 1802 and/or UI composer 1808. Query composer 1802 is shown sending a query string to UQE 1804 which can then provide the data to UI composer 1808. UI composer 1808 is then shown outputting view 1814 including table 1816 and/or cells 1818 (e.g., 1818-1 . . . 1818-N).

For example, in preparation for the rendering, a query collecting all required data needs to be constructed. An empty query descriptor is created in the query composer 1802. Then, starting with the Observe Page, each component in the composition tree specifies its information needs according to the applied template. The query composer 1802 uses this information to recursively build the query descriptor.

At the root of the descriptor there is the set of services specified by the Observe Page config: a set of services with the condition ‘environment=‘PROD”.

This is the ‘data’ input for the contained relationship map and the ocp. The relationship map config specifies a number of paths to related entities and their respective health attributes, so these paths (and aliases for the results as well as the mapping to the consuming component) are added to the query descriptor.

Likewise, the OCP Config is recursively evaluated: an alias for the data of the OCP already exists (because it is the same set of services that the relationship map consumes), now for this alias, additional required information is added for each element in the OCP. The topology map needs the relationships specified in ‘path’, the metric cards each specify a metric.

After this recursive gathering of information needs is complete, the query descriptor is translated into a UQL query string, which is sent to the UQE 1804.

The component tree is instantiated based on the templates. As far as the data binding is concerned, there are multiple possible implementations: One is to wait until all the data is available and instantiate the whole component tree with this data. Another approach could be that the query composer 1802 creates promises for each of the components, so that the instantiation can start immediately. This approach would also allow to immediately populate some of the components with content that is already cached.

A more detailed description of the process is now presented with regard to the query composer 1802 (High-level Design). In particular, in a composite soft-coded UI, each instance of a configurable component is bound to a data object which is defined by its parent component (similarly to the props of a React component which are defined by its parent component).

In contrast to React, however, there is no code that can fetch or calculate the data before passing it into a child component—everything is declaratively specified inside the respective component configurations. A dedicated module, the query composer, must derive the necessary queries and the binding of the result sets to the respective component instances.

In preparation for the rendering, an empty query descriptor is created in the query composer 1802. Then, starting with the Observe Page, each component in the composition tree specifies its information needs according to the applied template. The object collecting this information is the data request tree, which consists of nodes having
an alias for the result part
the type of the entity or metric the result represents
the path relative to its parent node
a pointer to the component class consuming the data
a pointer to the configuration

The data request tree reflects the structure of the component hierarchy.

Each configurable component is represented by a class with a method ‘addToQuery’, which receives the node of the data request tree corresponding to the input of the instantiated component. The method creates data request nodes for its sub-components (related entities, properties, metrics) based on the provided configuration, and adds them as child nodes to the data request tree. Then, the same method is recursively called for all of the embedded components with the new data request nodes as input.

As an example, the observe page binds to one or more focus entities, here a service (this entity is set from outside, by the page state). The observe page addoQuery method knows that an Observe page has two children: The Relationship Map and the OCP. So it creates two data request nodes. The names of the configurations for each are part of the Observe page configuration—but since the actual templates are type-specific, the method retrieves the matching templates for “apm:service” from the Template Registry. These templates are attached to the respective child data request nodes. Since the Observe page just passes its data (the focus entities) through to its direct children, the alias and type of the data are the same as for the parent node, and a relative path is not specified.

In the next recursion, the ‘addToQuery’ method of the Relationship Map is called. The provided template has a section “APM” which contains group visualizations for multiple related entity types, such as Service Instances. A child data request node is created for the related instances group. It has its own alias and entity type (“apm:ServiceInstance”). The specified path to get that data from the parent node is “apm:serviceToInstance”. The corresponding template configuring the entity group visualization for entity type “apm:ServiceInstance” could be dynamically selected if we want to visualize different entity types in different ways.

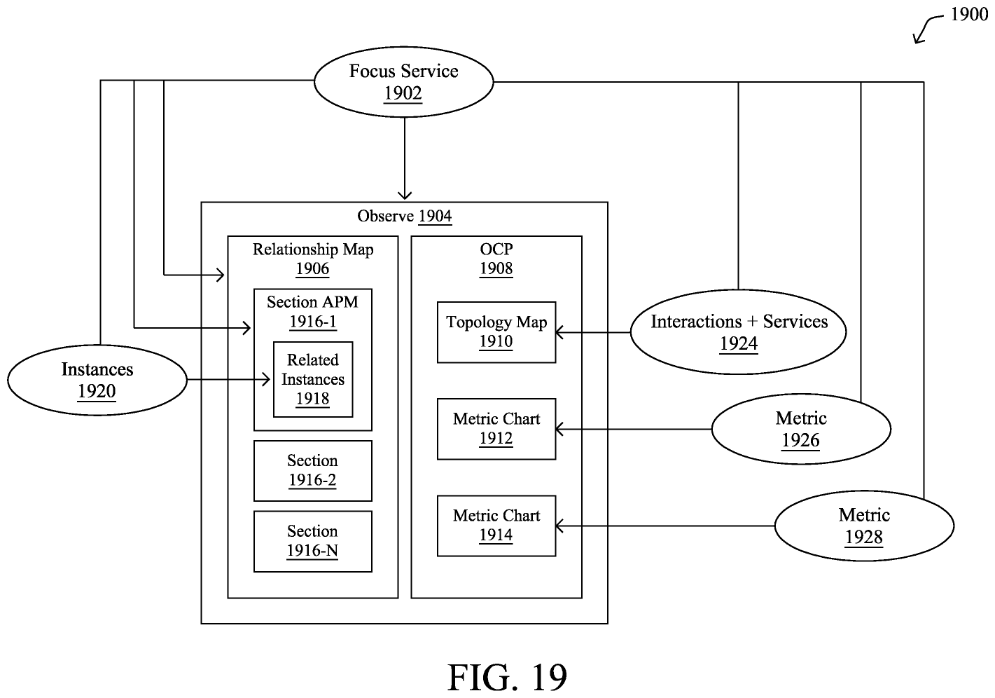

FIG. 19 illustrates an example composition hierarchy 1900 of the page and a simplified version of the corresponding tree of data request nodes (entities, metrics). Hierarchy 1900 includes instances 1920, interactions and services 1924, metric 1926, metric 1928, focus service 1902, relationship map 1906, section 1916 (e.g., 1916-1 . . . 1916-N), related instances 1918, OCP 1908, topology map 1910, metric chart 1912, metric chart 1914, etc.

In the straightforward case, the component hierarchy can be built in a single pass by evaluating the corresponding templates.

The query composer now calculates a consolidated data tree in which nodes with the same reference object and the same path name are merged together and receive a common alias. In the next processing step, the consolidated tree of data descriptors and their corresponding aliases is transformed into the FETCH and FROM parts of a UQL query, e.g.:
fetch
   s.metrics(apm:cpm),
   s.metrics(apm:art),
   si.property(name),
   si.property(hs:health)
from
   s=entities(apm:service:12345678902),
   si=s.serviceToInstance.to(apm:ServiceInstance)

After the query is executed, the result and the tree of component descriptors are passed to the UI Composer, which will then instantiate the corresponding component classes with their configuration and data, as described above with reference to FIG. 17 above.

Notably, the instantiation of configured component trees has been described above with reference to diagram 1600 of FIG. 16 above. In greater detail, in step 1 the tree of templates is mirrored in a tree of instantiators. An instantiator is an object that can create one or multiple instances of the specified UI element according to the configuration specified in the template. The instantiator constructor receives a “parent” Query node, and requests the necessary data (step 2), and potentially related entities (represented by “child query nodes”) it will need to create the element instance. The instantiator will recursively create instantiators for all contained elements, so that at the end the query node tree reflects the complete sub-graph under the root node which is needed to render the component tree.

After the query node tree is complete, it is used by the query composer to formulate the corresponding UQL query (step 3). The UQE connector retrieves the data (step 5) and transforms it into a tree of Data Nodes (corresponding to the datasets in the UQE result) (step 6). The data nodes are then recursively passed back to the respective instantiators (step 7) which then create the UI components using the configuration (which was passed to the constructor) and the data.

Notably, there are some special cases to consider herein, such as absolute data binding. In particular, some components specified in a template may not bind to an entity or metric/property of the parent component's data but rather specify their own absolute query, for example in order to display value ranges. In this case, the query composer will create a separate “root” query for this component (and any dependent child components).

Another special case to consider is dynamic template selection for unknown types. That is, the upfront calculation of query or queries for the whole component tree is only possible if all the templates are known. However, it is possible that the type (or sub-type) of a related entity cannot be derived from the model, and hence is only known when the respective entity is retrieved from the UQE. In these cases, the components for which the data is known are rendered, and the query composer is invoked again for the component nodes that could only be created once the applicable template is known. In an example, the Topology Map might contain empty graph nodes for a while until the data for the respective template is retrieved.

Advantageously, the techniques herein make it possible to declare activity-specific UIs as hierarchies of configured building blocks with coherent behavior without writing any glue code, which means that customers can create such pages without any implications for the software lifecycle of the application code itself. Compared to configurable dashboards, this solution has the following advantages:
Significant reduction of the number of required queries, reducing overhead and redundant selections on the backend.
Instead of writing/composing complete queries for each widget, the user only needs to specify data paths between parent and child components, which dramatically reduces the effort required, especially since preconfigured composite components can be reused.
As a side effect of the ability of the atomic building blocks to specify their information needs in the query composition (based on the provided configuration), the user is not bothered with specifying data transformations in the configuration, which often is a major effort in the definition of dashboards.

In addition, as a further overview of the config-driven UI herein, the config-driven UI allows the definition of OCPs and other UI elements by configuring, and composing in hierarchies of arbitrary depth, predefined base UI elements, such as labels, charts, graphs, tables, boxes, cards etc.

In contrast to the existing dashboard kits, where the user defines queries alongside with the widget configuration, the config-driven UI derives the queries itself based on the nesting structure and the information needs of the components in this structure. Because the extensibility platform data model is essentially a graph, the techniques herein can build complex pages by nesting configured components with very little effort: When adding a child component, the techniques herein only need to specify the relative path pointing from the entities of a parent element to the data (entities, metrics, attributes etc.) the child element. The whole query and the downstream data binding can be derived from this component tree.

Because of the upstream composition of the query (or queries) based on the component hierarchy, the overall design differs significantly from conventional data and control flow, where both the component structure and the exact query for each component are known upfront, so that each aggregate component knows (and needs to know) the exact data it has to pass down to its children and grandchildren.

In the config-driven UI, a parent component knows very little about its children. A child can even be a complete black box referenced by its name and receiving solely the relative path to the entities (or metrics) it should render.

With that path, the child component can order the exact data it needs (based on its configuration), not in the form of a separate, absolute query, but rather piggybacking on the query that is being composed for the parent element, which is available in the form of a _Query Node_ hierarchy. When the data is received from the backend, it will form a tree of _Data Nodes_ that mirrors the query node tree.

The ordering of the data, the selection of the right parts of the data node tree and creation of UI component instances is taken care of by _Instantiators_.

The diagram 1600 of FIG. 16 above illustrates the process: The soft-coded description of a UI is shown as a tree of _Templates_ on the left side. These templates are just objects which live in the JSON store and each describe the configuration and direct child elements of a base element). The ‘contains’ association shown actually is just a reference with attached configuration parameters (such as position, size, data path etc.)

Only when an OCP is to be rendered, the full hierarchy of the corresponding templates is embodied (step 1), by means of _Instantiators_ (one for each template). For each kind of base element there is a dedicated Instantiator class.

The root instantiator receives a query node that represents the _Scope_ of the OCP. The constructors of the instantiators evaluate their corresponding templates and “order” the required data via the query nodes (step 2). Whenever the path to a child element specifies a traversal to a related entity (or metric, event, log . . . ), a child query node is created, which serves as the reference for the corresponding child elements and so on.

Once the instantiators are all created and have ordered, the data can be fetched from UQE. In step 3, the query node tree is translated into one or multiple UQE queries, which are sent to the backend by the UQE Connector (4, 5). The received data is then converted from UQE's response format into a traversable tree structure of data nodes (6).

These data nodes are recursively passed down the instantiator hierarchy (7). Each instantiator can now create the UI elements described by its template (8). In contrast to conventional React programming, the React base components know nothing whatsoever about how their children are created. The instantiators create these elements recursively from the bottom up and each instantiator passes the created React components to its parent instantiator, which passes them into the props of the React element it creates itself.

The techniques herein further relate to “Interfaces”. For instance, both the data source and the request are interfaces an instantiator can use to order data. The only difference is that the data source can also be asked to actually fetch all of the ordered data. So the interfaces are:

```
[source file](../data/IDataSource.ts)
\grave{ }\grave{ }\grave{ }
/** Implemented by QueryNode **/
export interface IRequest {
  /**
    * @return the type of entities represented by this query node
    * This determines which attributes, metrics, and relationships
    * can be asked for
    */
  getEntityType( ): EntityType;
  /**
    * the alias which identifies the resulting data node in the
    * scope of its parent data node
    */
  getAlias( ): string;
  /**
    * The scope at the root of the query node tree
    */
  getScope( ): IScope;
  /**
    * use for nested queries: add a new node to the query/result tree
    * @param path
    * @param entityType
    */
  requestRelated(path: string, entityType: string): IRequest;
  /**
    * all-purpose data request, requires UQE syntax and is called by
    * requestAttribute and requestMetric
    * @param path
    * @return alias for the requested data
    */
  requestData(path: string): string;
  /**
    * only attribute name needs to be specified,
    * adds UQE syntax for attributes
    * @param name
    */
  requestAttribute(name: string): string;
  /**
    * only metric name (and, optionally, requested values) required
    * adds UQE syntax
    * @param metric
    * @param values
    */
  requestMetric(metric: string, values: aggregate Value[ ]): string;
}
\grave{ }\grave{ }\grave{ }
and
\grave{ }\grave{ }\grave{ }
/** Implemented by UqeDataSource */
export default interface IDataSource extends IRequest {
  fetchData(pageSize ?: number, page ?: number): Promise<IData>;
}
\grave{ }\grave{ }\grave{ }
```

The “data node” is a façade that makes the UQE response structure accessible, but preserves its basic array-based structure for the sake of minimizing memory consumption. However, it also offers the ability to create plain JS objects, which allows the mapping of field names and the access of values without a getter.

```
  [source file](../data/IData.ts)
  \grave{ }\grave{ }\grave{ }
  /** implemented by DataNode **/
  export interface IData {
    /**
      * tells whether the data is a single entity or an array
      */
    isSet( ): boolean;
    /**
      * type of the entity or entities in this data node
      */
    getType( ): EntityType;
    /**
      * returns metadata about all available fields
      */
    getHeaders( ): HeaderType[ ];
    / **
      * returns metadata about the specified field
      * @param key
      */
    getHeader(key: string): HeaderType;
    /**
      * Number of entities or rows
      */
    getElementCount( ): number;
    /**
      * Only for sets: returns the individual data nodes as array
      */
    getElements( ): IData[ ];
    /**
      * Returns the value of a specified field, can't be called for sets
      * @param alias field alias as specified in the corresponding query
node, alternatively field name if no alias was specified
      *
      */
    get(alias: string): any;
    / **
      * Converts an individual DataNode into a plain JS object
      * @param fieldMapping optional: keys are the requested keys for
the output, values the data node's field aliases
      */
    toPlainObject(fieldMapping?: { [key: string]: string }): {
        [key: string]: any;
    };
    /**
      * Converts a DataNode set into an array of plain JS objects
      * @param fieldMapping optional: keys are the requested keys for
the output, values the data node's field aliases
      * */
    toPlainArray(fieldMapping?: {
        [key: string]: string;
    }): { [key: string]: any }[ ];
  }
  \grave{ }\grave{ }\grave{ }
```

The anatomy/logic of an instantiator is essentially contained in two methods:
The constructor, which stores the configuration parameters in member variables and orders the required data.
The ‘createElement’ method which receives the data and contextual configurations from the parent React element
   In addition, an instantiator handles all state that affects child components (since the React components can't create children themselves).

As an example, assume a “LabelInstantiator”. The simplest base element is a label. A label displaying the name of an entity can be configured like this:

```
\grave{ }\grave{ }\grave{ }json
  {
    “kind”: “label”,
    “key”: “Name”,
    “path”: “attributes(name)”,
    “style”: { “color”: “#fff” }
  }
\grave{ }\grave{ }\grave{ }
```

The pair “kind”: “label”' indicates that the LabelInstantiator will process this configuration object, the key translates directly into the key of the React element. ‘path’ specifies the data to be displayed. It can be an attribute of the reference entity, but it can also be derived from a related entity. For example, “path”: “-has_instance->(service_instance)#count” will evaluate the number of related instances. The “style”' configuration specifies (part of) the generated label's css style.

Regarding a constructor:

```
\grave{ }\grave{ }\grave{ }
constructor(parentQueryNode: IRequest, descriptor: Descriptor) {
  const { path, unit, style } = descriptor;
  const { fullPath, fieldName, targetType } = parseArrowPath(path);
  let sourceNode = parentQueryNode;
  if (fullPath) {
    const traversedNode = parentQueryNode.requestRelated(
      fullPath,
      targetType
    );
    this.traversedAlias = traversedNode.getAlias( );
    sourceNode = traversedNode;
  }
  this.alias = sourceNode.requestData(fieldName);
  this.unit = unit;
  this.style = style;
}
\grave{ }\grave{ }\grave{ }
```

The line ‘this.alias=sourceNode.requestData(fieldName)’ requests the data from the corresponding query node. The data path for a label is always the field name, however, that field name can refer to a different entity if traversal is part of the configured path (such as in ‘-has_instance->(service_instance)’). Once the corresponding source node is determined, the data is ordered in ‘this.alias=sourceNode.requestData(fieldName);’ The alias has the function of a handle, it will be used in the ‘createElement’ method to get the right data from the data node:

```
Regarding a “CreateElement”:
  \grave{ }\grave{ }\grave{ }
  createElement(dataNode: IData, key: string, config: instanceConfig) {
      const sourceNode: IData = this.traversedAlias
    ? dataNode.get(this.traversedAlias)
    : dataNode;
  const content = sourceNode.get(this.alias);
  const boxConfig = {
    ...(config || { }),
    style: { ...this.style, ... config?.style },
  };
  return (
    <Box key={key} config={boxConfig}>
      {content}
    </Box>
  );
  \grave{ }\grave{ }\grave{ }
```

The important thing to note here is that in case of a traversal to a different entity type (service instances in the example), the right data node needs to be asked for the data. Choosing that data node is what happens in the lines:

```
\grave{ }\grave{ }\grave{ }
const sourceNode: IData = this.traversedAlias
  ? dataNode.get(this.traversedAlias)
  : dataNode;
\grave{ }\grave{ }\grave{ }
```

Another important aspect of the instantiator is that configuration parameters are passed two times: The ‘constructor’ can receive the configuration parameters (such as ‘style’) as part of the descriptor. These are properties that are independent of the context. Then there is a ‘config’ argument in ‘createElement’, which contains properties that depend on the context, i.e. the parent elements, in which the component is instantiated.

The contextual properties can override static properties. For example, the ‘TableInstantiator’ creates rows that have alternating background colors. In order to achieve that, the ‘RowInstantiator’ receives the background color for its respective row as ‘style’ in the contextual config.

Another important class of properties that are passed as part of the ‘createElement’ config argument are event handlers, such as “onClick” or “onSelect”.

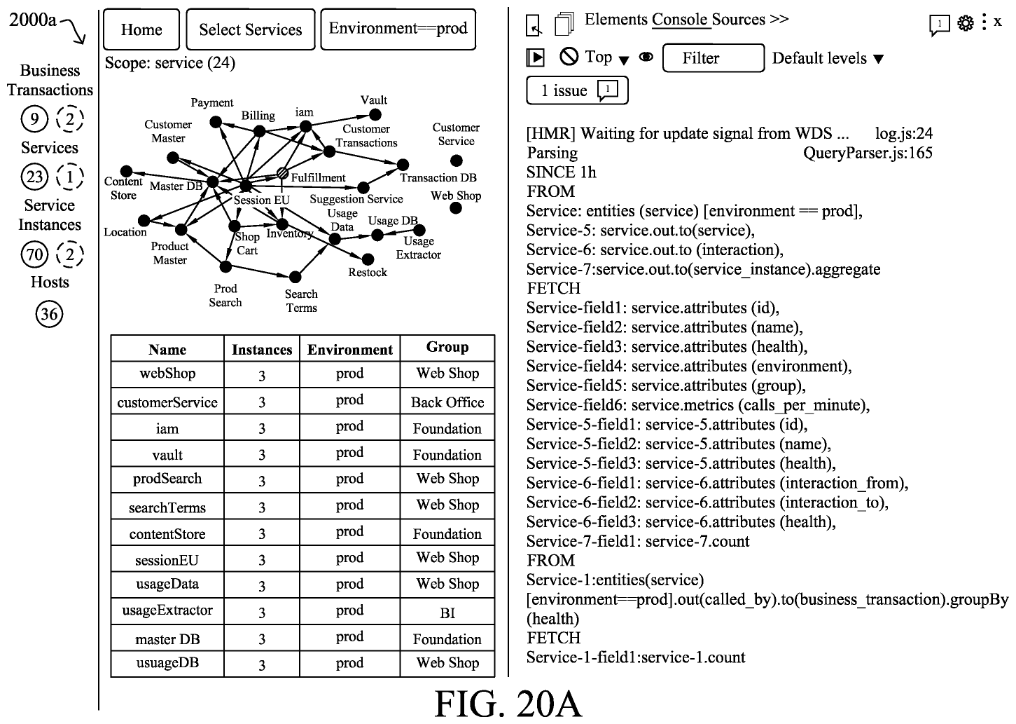

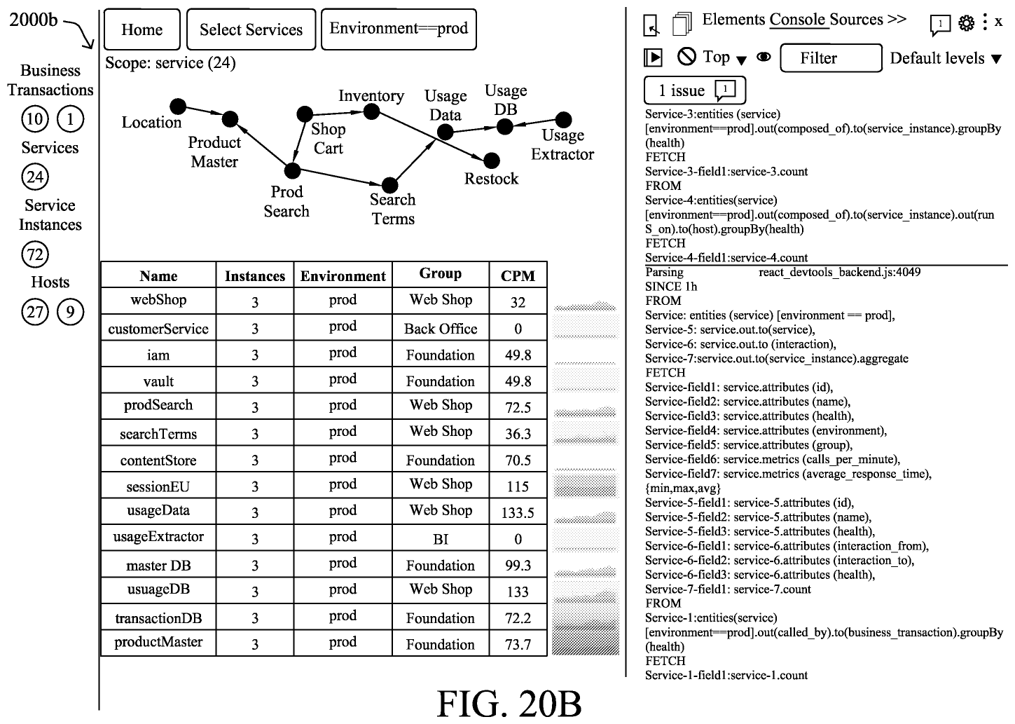

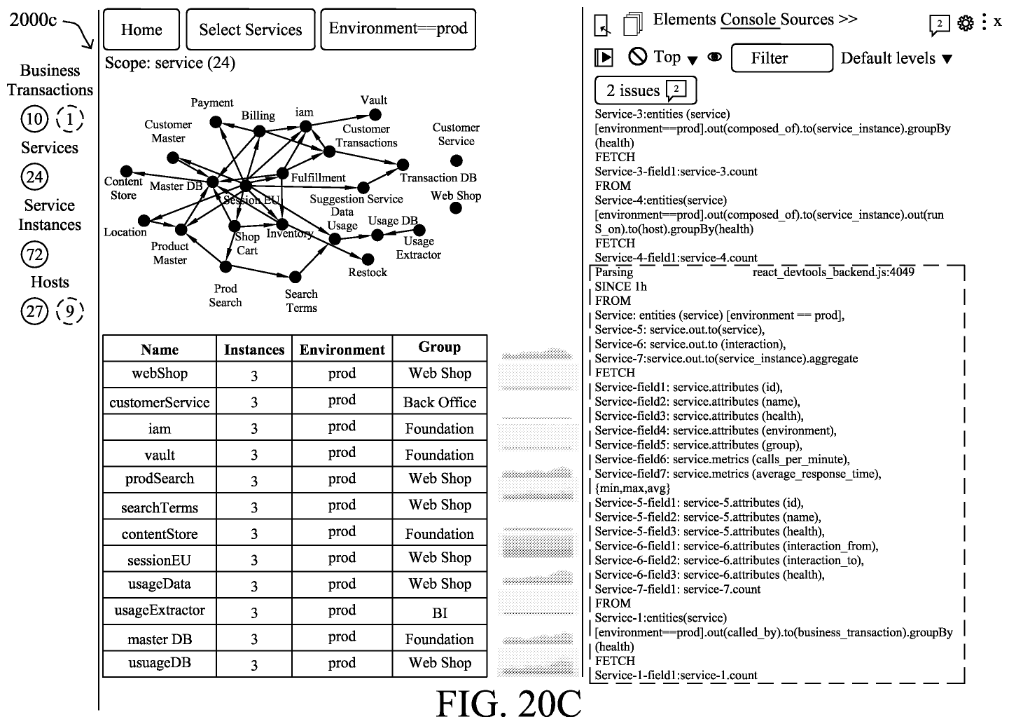

FIGS. 20A-20C illustrate example screenshots 2000a-c of a resultant dashboard according to the techniques herein.

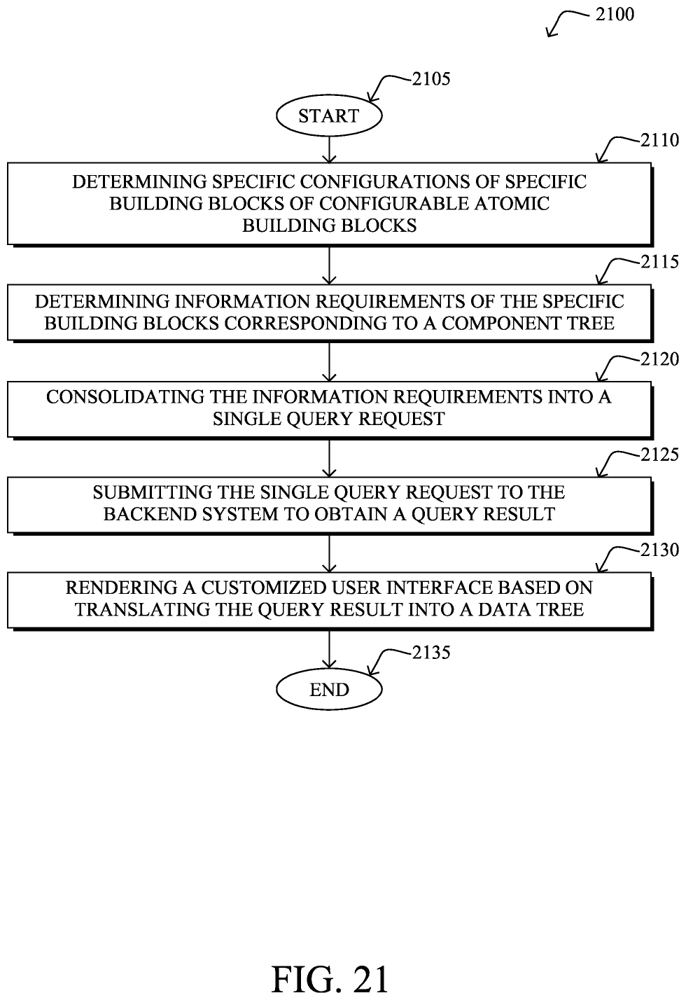

In closing, FIG. 21 illustrates an example simplified procedure for a configuration-driven query composition for graph data structures for an extensibility platform, in accordance with one or more embodiments described herein. For example, a non-generic, specifically configured device (e.g., device 200) may perform procedure 2100 by executing stored instructions (e.g., extensibility platform process 248). The procedure 2100 may start at step 2105, and continues to step 2110, where, as described in greater detail above, a process may include determining, for a particular customized user interface instance, specific configurations of one or more specific building blocks of a plurality of configurable atomic building blocks provided by a user interface platform, the specific configurations defining hierarchies between child component data and parent component data that result in a component tree. The user interface platform may comprise an extensibility platform configured to monitor observability data of a computer network topology. The plurality of configurable atomic building blocks for the user interface platform may be provided via one or more hard-coded software widgets.

In various embodiments, the plurality of configurable atomic building blocks comprise one or more of simple blocks, composite blocks, or blocks that contain parts that are dynamically populated by other building blocks. One or more of the plurality of configurable atomic building blocks may comprise one or more templates to visualize entities and/or observability data. The process may further comprise determining specific templates of the one or more templates based on configuration of a corresponding building block of the one or more specific building blocks.

One or more of the plurality of configurable atomic building blocks may comprise a relationship map that defines domain-specific segments with paths for corresponding relationships between entities. The relationship map may further define a health attribute to evaluate for the corresponding relationships. The process may further comprise receiving a patch for the relationship map from a different domain to add segments to the corresponding relationships.

One or more of the plurality of configurable atomic building blocks may comprise a topology map that embeds template-based components for nodes within a topology. A connection type specified within the topology map may define associated entities within the topology. In some embodiment, one or more of the plurality of configurable atomic building blocks may comprise a card that allows composition of elements selected from a group consisting of: cards, charts, divs, and images; wherein data input into the card is applied to an entity defined within the card. Contextual properties may override static properties within the specific configurations.

At step 2115, as detailed above, the process may include determining one or more information requirements of the one or more specific building blocks corresponding to components of the component tree.

As noted above, at step 2120 the process may include consolidating the one or more information requirements into a single query request according to query language of a backend system. The single query request may consist of a single continuous subgraph.

Further the above detailed description, at step 2125 the process may include submitting the single query request to the backend system to obtain a query result.

At step 2130, the process may include rendering the particular customized user interface instance based on translating the query result into a data tree that recursively passes the query result from parent components to child components within the component tree, as detailed above. In various embodiments, rendering may comprise instantiating a user interface element by combining a supplied template within a particular building block with corresponding data from the query result. In some instances, rendering may comprise waiting for all data to be available from the query result prior to rendering the particular customized user interface instance.

Additionally, rendering may comprise rendering available data within the particular customized user interface instance prior to completion of the query result. In various embodiments, rendering may comprise generating one or more user interface elements selected from a group consisting of: labels, charts, graphs, tables, boxes, and cards.

The process may include implementing one or more instantiators to each create one or more user interface elements of the particular customized user interface instance according to the specific configurations of templates in the one or more specific building blocks.

The simplified procedure 2100 may then end in step 2135, notably with the ability to continue determining updates to specific configurations and/or updating the rendering of the particular customized user interface. Other steps may also be included generally within procedure 2100.

The techniques described herein, therefore, introduce mechanisms for a configuration-driven query composition for graph data structures for an extensibility platform. All data structures can be seen as graphs of entities, where each entity has properties and relationships to other entities. An activity-specific User Interface typically displays one subgraph centered around a currently selected set of entities (the scope). Also, the composition tree of the components is typically reflected by one or multiple tree structures embedded in said subgraph. Because that data path is relative, and doesn't require knowledge of the absolute definition of information represented by the parent component, it is possible to dynamically configure hierarchies of components and then derive the full structure of the subgraph required to render these components from the data paths. Combined with the knowledge of the set of entities bound to the root component (the scope), this structure can then be translated into an optimized query with no redundant requests, which provides the data required to render the UI. In combination with a backend providing some form of query language that supports dynamically querying graph structures, new activity specific UIs can be developed by mere configuration without making any changes to frontend or backend code. Said differently, the new approach described herein consolidates the information needs of multiple specific building blocks (or “widgets”) in a single query in order to retrieve a contiguous subgraph from the backend that can feed all the widgets with information at once (thus minimizing the number of roundtrips, avoiding any redundant queries, and so on).

Illustratively, the techniques described herein may be performed by hardware, software, and/or firmware, such as in accordance with the illustrative extensibility platform process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, an illustrative method herein may comprise: determining, by a process and for a particular customized user interface instance, specific configurations of one or more specific building blocks of a plurality of configurable atomic building blocks provided by a user interface platform, the specific configurations defining hierarchies between child component data and parent component data that result in a component tree; determining, by the process, one or more information requirements of the one or more specific building blocks corresponding to components of the component tree; consolidating, by the process, the one or more information requirements into a single query request according to query language of a backend system, the single query request consisting of a single continuous subgraph; submitting, by the process, the single query request to the backend system to obtain a query result; and rendering, by the process, the particular customized user interface instance based on translating the query result into a data tree that recursively passes the query result from parent components to child components within the component tree.

In one embodiment, the user interface platform comprises an extensibility platform configured to monitor observability data of a computer network topology. In one embodiment, the method further comprises providing the plurality of configurable atomic building blocks for the user interface platform via one or more hard-coded software widgets. In one embodiment, the plurality of configurable atomic building blocks comprise one or more of simple blocks, composite blocks, or blocks that contain parts that are dynamically populated by other building blocks. In one embodiment, rendering comprises instantiating a user interface element by combining a supplied template within a particular building block with corresponding data from the query result.

In one embodiment, one or more of the plurality of configurable atomic building blocks comprise one or more templates to visualize entities and/or observability data. In one embodiment, the method may comprise determining specific templates of the one or more templates based on configuration of a corresponding building block of the one or more specific building blocks. In one embodiment, one or more of the plurality of configurable atomic building blocks comprise a relationship map that defines domain-specific segments with paths for corresponding relationships between entities. In one embodiment, the relationship map further defines a health attribute to evaluate for the corresponding relationships.

In one embodiment, the method further comprises receiving a patch for the relationship map from a different domain to add segments to the corresponding relationships. In one embodiment, one or more of the plurality of configurable atomic building blocks comprise a topology map that embeds template-based components for nodes within a topology. In one embodiment, a connection type specified within the topology map defines associated entities within the topology. In one embodiment, one or more of the plurality of configurable atomic building blocks comprise a card that allows composition of elements selected from a group consisting of: cards, charts, divs, and images; wherein data input into the card is applied to an entity defined within the card.

In one embodiment, rendering comprises waiting for all data to be available from the query result prior to rendering the particular customized user interface instance. In one embodiment, rendering comprises rendering available data within the particular customized user interface instance prior to completion of the query result. In one embodiment, rendering comprises generating one or more user interface elements selected from a group consisting of: labels, charts, graphs, tables, boxes, and cards. In one embodiment, the method further comprises implementing one or more instantiators to each create one or more user interface elements of the particular customized user interface instance according to the specific configurations of templates in the one or more specific building blocks. In one embodiment, contextual properties override static properties within the specific configurations.

According to the embodiments herein, an illustrative tangible, non-transitory, computer-readable medium herein may have computer-executable instructions stored thereon that, when executed by a processor on a computer, may cause the computer to perform a method comprising: determining, for a particular customized user interface instance, specific configurations of one or more specific building blocks of a plurality of configurable atomic building blocks provided by a user interface platform, the specific configurations defining hierarchies between child component data and parent component data that result in a component tree; determining one or more information requirements of the one or more specific building blocks corresponding to components of the component tree; consolidating the one or more information requirements into a single query request according to query language of a backend system, the single query request consisting of a single continuous subgraph; submitting the single query request to the backend system to obtain a query result; and rendering the particular customized user interface instance based on translating the query result into a data tree that recursively passes the query result from parent components to child components within the component tree.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: determine, for a particular customized user interface instance, specific configurations of one or more specific building blocks of a plurality of configurable atomic building blocks provided by a user interface platform, the specific configurations defining hierarchies between child component data and parent component data that result in a component tree; determine one or more information requirements of the one or more specific building blocks corresponding to components of the component tree; consolidate the one or more information requirements into a single query request according to query language of a backend system, the single query request consisting of a single continuous subgraph; submit the single query request to the backend system to obtain a query result; and render the particular customized user interface instance based on translating the query result into a data tree that recursively passes the query result from parent components to child components within the component tree.

While there have been shown and described illustrative embodiments above, it is to be understood that various other adaptations and modifications may be made within the scope of the embodiments herein. For example, while certain embodiments are described herein with respect to certain types of applications in particular, such as the observability intelligence platform, the techniques are not limited as such and may be used with any computer application, generally, in other embodiments. For example, as opposed to observability and/or telemetry data, particularly as related to computer networks and associated metrics (e.g., pathways, utilizations, etc.), other application platforms may also utilize the general extensibility platform described herein, such as for other types of data-based user interfaces, other types of data ingestion and aggregation, and so on, may also benefit from the extensibility platform described herein.

Moreover, while specific technologies, languages, protocols, and associated devices have been shown, such as Java, TCP, IP, and so on, other suitable technologies, languages, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a process and for a particular customized user interface instance, specific configurations of one or more specific building blocks of a plurality of configurable atomic building blocks provided by a user interface platform, the specific configurations defining hierarchies between child component data and parent component data that result in a component tree;
determining, by the process, one or more information requirements of the one or more specific building blocks corresponding to components of the component tree;
consolidating, by the process, the one or more information requirements into a single query request according to query language of a backend system, the single query request consisting of a single continuous subgraph;
submitting, by the process, the single query request to the backend system to obtain a query result; and
rendering, by the process, the particular customized user interface instance based on translating the query result into a data tree that recursively passes the query result from parent components to child components within the component tree.

2. The method as in claim 1, wherein the user interface platform comprises an extensibility platform configured to monitor observability data of a computer network topology.

3. The method as in claim 1, further comprising:
providing the plurality of configurable atomic building blocks for the user interface platform via one or more hard-coded software widgets.

4. The method as in claim 1, wherein the plurality of configurable atomic building blocks comprise one or more of simple blocks, composite blocks, or blocks that contain parts that are dynamically populated by other building blocks.

5. The method as in claim 1, wherein rendering comprises:
instantiating a user interface element by combining a supplied template within a particular building block with corresponding data from the query result.

6. The method as in claim 1, wherein one or more of the plurality of configurable atomic building blocks comprise one or more templates to visualize entities and/or observability data.

7. The method as in claim 6, further comprising:
determining specific templates of the one or more templates based on configuration of a corresponding building block of the one or more specific building blocks.

8. The method as in claim 1, wherein one or more of the plurality of configurable atomic building blocks comprise a relationship map that defines domain-specific segments with paths for corresponding relationships between entities.

9. The method as in claim 8, wherein the relationship map further defines a health attribute to evaluate for the corresponding relationships.

10. The method as in claim 8, further comprising:
receiving a patch for the relationship map from a different domain to add segments to the corresponding relationships.

11. The method as in claim 1, wherein one or more of the plurality of configurable atomic building blocks comprise a topology map that embeds template-based components for nodes within a topology.

12. The method as in claim 11, wherein a connection type specified within the topology map defines associated entities within the topology.

13. The method as in claim 1, wherein one or more of the plurality of configurable atomic building blocks comprise a card that allows composition of elements selected from a group consisting of: cards, charts, divs, and images; wherein data input into the card is applied to an entity defined within the card.

14. The method as in claim 1, wherein rendering comprises:
waiting for all data to be available from the query result prior to rendering the particular customized user interface instance.

15. The method as in claim 1, wherein rendering comprises:
rendering available data within the particular customized user interface instance prior to completion of the query result.

16. The method as in claim 1, wherein rendering comprises:
generating one or more user interface elements selected from a group consisting of: labels, charts, graphs, tables, boxes, and cards.

17. The method as in claim 1, further comprising:
implementing one or more instantiators to each create one or more user interface elements of the particular customized user interface instance according to the specific configurations of templates in the one or more specific building blocks.

18. The method as in claim 1, wherein contextual properties override static properties within the specific configurations.

19. A tangible, non-transitory, computer-readable medium having computer-executable instructions stored thereon that, when executed by a processor on a computer, cause the computer to perform a method comprising:
determining, for a particular customized user interface instance, specific configurations of one or more specific building blocks of a plurality of configurable atomic building blocks provided by a user interface platform, the specific configurations defining hierarchies between child component data and parent component data that result in a component tree;
determining one or more information requirements of the one or more specific building blocks corresponding to components of the component tree;
consolidating the one or more information requirements into a single query request according to query language of a backend system, the single query request consisting of a single continuous subgraph;
submitting the single query request to the backend system to obtain a query result; and
rendering the particular customized user interface instance based on translating the query result into a data tree that recursively passes the query result from parent components to child components within the component tree.

20. An apparatus, comprising:
one or more network interfaces to communicate with a network;
a processor coupled to the one or more network interfaces and configured to execute one or more processes;
a memory configured to store a process that is executable by the processor, the process, when executed, configured to:
determine, for a particular customized user interface instance, specific configurations of one or more specific building blocks of a plurality of configurable atomic building blocks provided by a user interface platform, the specific configurations defining hierarchies between child component data and parent component data that result in a component tree;
determine one or more information requirements of the one or more specific building blocks corresponding to components of the component tree;
consolidate the one or more information requirements into a single query request according to query language of a backend system, the single query request consisting of a single continuous subgraph;
submit the single query request to the backend system to obtain a query result; and
render the particular customized user interface instance based on translating the query result into a data tree that recursively passes the query result from parent components to child components within the component tree.
